(19) United States
(12) Patent Application Publication
(10) Pub. No.: US 2025/0061855 A1
(43) Pub. Date: Feb. 20, 2025

(54) PIXEL CIRCUIT, DISPLAY APPARATUS AND DRIVING METHOD

(71) Applicants: Chengdu BOE Optoelectronics Technology Co., Ltd., Chengdu,Sichuan Province (CN); BOE Technology Group Co., Ltd., Beijing (CN)

(72) Inventors: Bangqing XIAO, Beijing (CN); Benlian WANG, Beijing (CN); Haigang QING, Beijing (CN); Yi ZHANG, Beijing (CN); Hai ZHENG, Beijing (CN); Tianyi CHENG, Beijing (CN)

(21) Appl. No.: 18/728,794

(22) PCT Filed: Mar. 14, 2023
(86) PCT No.: PCT/CN2023/081402

§ 371 Date: Jul. 12, 2024

(51) Int. Cl. G09G 3/3233; G09G 3/32

(52) U.S. Cl. CPC G09G 3/3233; G09G 3/32; G09G 2300/0819; G09G 2300/0842; G09G 2300/0861; G09G 2310/08; G09G 2320/0247; G09G 2320/0257; G09G 2340/0435

(57) ABSTRACT

Provided are a pixel circuit, display apparatus and driving method. The pixel circuit includes: a light-emitting device, a driving transistor configured to generate a driving current that drives the light-emitting device to emit light according to a data voltage, a light-emitting control circuit coupled with the driving transistor and configured to, in response to an effective level of a light-emitting control signal terminal, provide a driving current generated by the driving transistor to the light-emitting device, and drive the light-emitting device to emit light; a data-writing circuit coupled with a first electrode of the driving transistor and configured to operate in response to a plurality of effective levels that occur at intervals between first scanning signal terminals; and a threshold compensation circuit coupled with the driving transistor.

### CROSS REFERENCE TO RELATED APPLICATIONS

The present disclosure is a US National Stage of International Application No. PCT/CN2023/081402, filed on Mar. 14, 2023, the entire contents of which are incorporated herein by reference.

### TECHNICAL FIELD

The disclosure relates to the technical field of display, especially to a pixel circuit, display apparatus and driving method.

### BACKGROUND

Light-emitting devices, such as organic light-emitting diodes (OLED), quantum dot light-emitting diodes (QLED), micro light-emitting diodes (Micro LED), mini light-emitting diodes (Mini LED) and the like, have the advantages of self-illumination and low energy consumption, and are one of hot spots in the field of display apparatus application research. In general, pixel circuits are used in display apparatuses to drive the light-emitting devices to emit light.

### SUMMARY

Embodiments of the present disclosure provide a pixel circuit, including:
a light-emitting device;
a driving transistor configured to generate a driving current that drives the light-emitting device to emit light according to a data voltage;
a light-emitting control circuit coupled with the driving transistor, and configured to, in response to an effective level of a light-emitting control signal terminal, provide the driving current generated by the driving transistor to the light-emitting device, and drive the light-emitting device to emit light;
a data-writing circuit coupled with a first electrode of the driving transistor, and configured to operate in a data refresh phase in response to a plurality of effective levels that occur at intervals between first scanning signal terminals; and
a threshold compensation circuit coupled with the driving transistor, configured to, in response to an effective level of a compensation control signal terminal, input a threshold voltage of the driving transistor into a gate of the driving transistor;
where in the data refresh phase, a time period of an invalid level of the light-emitting control signal terminal includes a time period of the effective level of the compensation control signal terminal and a time period of an effective level of the first scanning signal terminal, the effective level of the first scanning signal terminal includes at least one first effective level and at least one second effective level, and the time period of the effective level of the compensation control signal terminal includes a time period of the first effective level.

In some possible embodiments, in the data refresh phase, a time period of the at least one second effective level occurs after the time period of the effective level of the compensation control signal terminal.

In some possible embodiments, in the data refresh phase, a time period of the at least one second effective level occurs before the time period of the effective level of the compensation control signal terminal.

In some possible embodiments, the pixel circuit further includes: a first initialization circuit, where the first initialization circuit is coupled with the first electrode of the driving transistor;
the first initialization circuit is configured to, in response to at least one effective level of a first reset control signal terminal in the data refresh phase, provide a signal of the first initialization signal terminal to the first electrode of the driving transistor;
where in the data refresh phase, the time period of the invalid level of the light-emitting control signal terminal further includes a time period of the effective level of the first reset control signal terminal, and the time period of the effective level of the first reset control signal terminal does not overlap with a time period of a plurality of effective levels of the first scanning signal terminal.

In some possible embodiments, the effective level of the first reset control signal terminal includes at least one third effective level;
in the data refresh phase, a time period of the at least one third effective level occurs after the time period of the plurality of effective levels of the first scanning signal terminal.

In some possible embodiments, the effective level of the first reset control signal terminal includes at least one fourth effective level;
in the data refresh phase, the time period of the effective level of the compensation control signal terminal includes a time period of the fourth effective level, and the time period of the fourth effective level occurs before a time period of the first effective level of the first scanning signal terminal.

In some possible embodiments, the pixel circuit further includes: a second initialization circuit, where the second initialization circuit is coupled with a second electrode of the driving transistor;
the second initialization circuit is configured to, in response to at least one effective level of a second reset control signal terminal, provide a signal of a second initialization signal terminal to the second electrode of the driving transistor;
in the data refresh phase, the time period of the invalid level of the light-emitting control signal terminal includes a time period of the effective level of the second reset control signal terminal, and the time period of the effective level of the second reset control signal terminal does not overlap with a time period of a plurality of effective levels in the first scanning signal terminal.

In some possible embodiments, the effective level of the second reset control signal terminal includes at least one fifth effective level;
in the data refresh phase, the time period of the effective level of the compensation control signal terminal includes a time period of the at least one fifth effective level, and the time period of the at least one fifth effective level occurs before a time period of at least one first effective level of the first scanning signal terminal.

In some possible embodiments, in the data refresh phase, the time period of the fifth effective level occurs before or after a time period of a fourth effective level of a first reset control signal terminal.

In some possible embodiments, the effective level of the second reset control signal terminal includes at least one sixth effective level;
in the data refresh phase, a time period of the at least one sixth effective level occurs after or before the time period of the effective level of the compensation control signal terminal.

In some possible embodiments, the pixel circuit further includes a third initialization circuit, and the third initialization circuit is coupled with the light-emitting device;
the third initialization circuit is configured to, in response to an effective level of a third reset control signal terminal, provide a signal of the third initialization signal terminal to the light-emitting device.

In some possible embodiments, one of the compensation control signal terminal, the first scanning signal terminal, a first reset control signal terminal and a second reset control signal terminal is a signal terminal same as the third reset control signal terminal.

In some possible embodiments, a display frame corresponding to the pixel circuit includes a refresh sub-frame and a maintaining sub-frame, and an operation of the pixel circuit in the refresh sub-frame is an operation of the pixel circuit in the data refresh phase.

In some possible embodiments, the compensation control signal terminal includes an invalid level in the maintaining sub-frame;
the light-emitting control signal terminal includes an invalid level and an effective level in at least one maintaining sub-frame;
the first scanning signal terminal includes an invalid level and an effective level in at least one maintaining sub-frame.

In some possible embodiments, a first reset control signal terminal includes an invalid level and an effective level in at least one maintaining sub-frame; or
a first reset control signal terminal includes an invalid level in the maintaining sub-frame.

In some possible embodiments, a second reset control signal terminal includes an invalid level and an effective level in at least one maintaining sub-frame; or a second reset control signal terminal includes an invalid level in the maintaining sub-frame.

In some possible embodiments, a third reset control signal terminal includes an invalid level and an effective level in at least one maintaining sub-frame; or
a third reset control signal terminal includes an invalid level in the maintaining sub-frame.

In some possible embodiments, the data-writing circuit includes a first transistor; a gate of the first transistor is coupled with the first scanning signal terminal, a first electrode of the first transistor is coupled with a data signal terminal, and a second electrode of the first transistor is coupled with the first electrode of the driving transistor;
the threshold compensation circuit includes a second transistor and a storage capacitor; a gate of the second transistor is coupled with the compensation control signal terminal, a first electrode of the second transistor is coupled with the gate of the driving transistor, a second electrode of the second transistor is coupled with a second electrode of the driving transistor; a first electrode plate of the storage capacitor is coupled with the gate of the driving transistor, and a second electrode plate of the storage capacitor is coupled with a first power supply terminal;
the light-emitting control circuit includes a third transistor and a fourth transistor; a gate of the third transistor is coupled with the light-emitting control signal terminal, a first electrode of the third transistor is coupled with the first power supply terminal, a second electrode of the third transistor is coupled with the first electrode of the driving transistor, a gate of the fourth transistor is coupled with the light-emitting control signal terminal, a first electrode of the fourth transistor is coupled with the second electrode of the driving transistor, and a second electrode of the fourth transistor is coupled with the light-emitting device;
a first initialization circuit includes a fifth transistor, a gate of the fifth transistor is coupled with the first reset control signal terminal, a first electrode of the fifth transistor is coupled with the first initialization signal terminal, and a second electrode of the fifth transistor is coupled with the first electrode of the driving transistor;
a second initialization circuit includes a sixth transistor, a gate of the sixth transistor is coupled with a second reset control signal terminal, a first electrode of the sixth transistor is coupled with a second initialization signal terminal, and a second electrode of the sixth transistor is coupled with the second electrode of the driving transistor;
a third initialization circuit includes a seventh transistor; a gate of the seventh transistor is coupled with a third reset control signal terminal, a first electrode of the seventh transistor is coupled with a third initialization signal terminal, and a second electrode of the seventh transistor is coupled with the light-emitting device.

Embodiments of the present disclosure further provide a pixel circuit, including:
a light-emitting device;
a driving transistor configured to generate a driving current that drives the light-emitting device to emit light according to a data voltage;
a light-emitting control circuit coupled with the driving transistor, and configured to, in response to an effective level of a light-emitting control signal terminal, provide the driving current generated by the driving transistor to the light-emitting device, and drive the light-emitting device to emit light;
a functional circuit coupled with the driving transistor, and configured to, in response to a plurality of effective levels that occur at intervals between second scanning signal terminals, operate in a data refresh phase;
a threshold compensation circuit coupled with the driving transistor, and configured to, in response to an effective level of a compensation control signal terminal, input a threshold voltage of the driving transistor into a gate of the driving transistor;
where in the data refresh phase, a time period of an invalid level of the light-emitting control signal terminal includes a time period of an effective level of the compensation control signal terminal and a time period of an effective level of the second scanning signal terminal, the effective level of the second scanning signal terminal includes at least one seventh effective level and at least one eighth effective level, and the time period of the effective level of the compensation control signal terminal does not overlap with a time period of the at least one eighth effective level.

In some possible embodiments, the time period of the effective level of the compensation control signal terminal includes a time period of the seventh effective level.

In some possible embodiments, in the data refresh phase, the time period of the at least one eighth effective level occurs before or after the time period of the effective level of the compensation control signal terminal.

Embodiments of the present disclosure further provide a display panel including a plurality of sub-pixels;
each of the plurality of sub-pixels includes the pixel circuit as described above.

In some possible embodiments, in the data refresh phase, a plurality of effective levels of the first scanning signal terminal of the pixel circuit include at least one second effective level;

in response to that a time period of at least one second effective level in the at least one second effective level occurs after the time period of the effective level of the compensation control signal terminal, a time period of the second effective level corresponding to a pixel circuit in a n^{th} row of sub-pixels overlaps with a time period of the first effective level corresponding to a pixel circuit in a (n+m)^{th} row of sub-pixels, wherein n is an integer and n>0, and m is an integer and m>0.

In some possible embodiments, in the data refresh phase, a plurality of effective levels of the first scanning signal terminal of the pixel circuit include at least one second effective level;
in the data refresh phase, in response to a time period of at least one second effective level in the at least one second effective level occurs before the time period of the effective level of the compensation control signal terminal, a time period of the second effective level corresponding to a pixel circuit in a q^{th} row of sub-pixels overlaps with a time period of the first effective level corresponding to a pixel circuit in a (q−k)^{th} row of sub-pixels, wherein q is an integer and q>0, and k is an integer and k>0.

In some possible embodiments, a time period of the effective level of the compensation control signal terminal of a pixel circuit in a s^{th} row of sub-pixels includes a time period of the first effective level corresponding to a pixel circuit in the s^{th} to (s−a)^{th} rows of sub-pixels, and a is an integer and a>0.

In some possible embodiments, a time period of the effective level of the compensation control signal terminal of a pixel circuit in a s^{th} row of sub-pixels includes a time period of the first effective level corresponding to a pixel circuit in the s^{th} to (s+b)^{th} rows of sub-pixels, and b is an integer and b>0.

Embodiments of the present disclosure further provide a display apparatus, including the display panel as described above.

Embodiments of the present disclosure further provide a driving method for the pixel circuit as described above, including: the data refresh phase; where the data refresh phase includes:
in a data threshold compensation phase, operating, by the data-writing circuit, in response to a first effective level of the first scanning signal terminal, and inputting, by the threshold compensation circuit, the threshold voltage of the driving transistor into the gate of the driving transistor in response to the effective level of the compensation control signal terminal;
in a first initialization auxiliary phase, providing, by the data-writing circuit, in response to the second effective level of the first scanning signal terminal, the data voltage of the data signal terminal to the first electrode of the driving transistor;
in a light-emitting stage, providing, by the light-emitting control circuit, the driving current generated by the driving transistor to the light-emitting device to drive the light-emitting device to emit light in response to the effective level of the light-emitting control signal terminal.

Embodiments of the present disclosure further provide a driving method for the pixel circuit as described above, including:
in a second initialization auxiliary phase, providing, by the data-writing circuit, in response to the third effective level of the first scanning signal terminal, the data voltage of the data signal terminal to the first electrode of the driving transistor;
in a data threshold compensation phase, providing, by the data-writing circuit, in response to the first effective level of the first scanning signal terminal, the data voltage of the data signal terminal to the first electrode of the driving transistor, and inputting, by the threshold compensation circuit, the threshold voltage of the driving transistor into the gate of the driving transistor in response to the effective level of the compensation control signal terminal;
in a light-emitting stage, providing, by the light-emitting control circuit, the driving current generated by the driving transistor to the light-emitting device to drive the light-emitting device to emit light in response to the effective level of the light-emitting control signal terminal.

### BRIEF DESCRIPTION OF FIGURES

FIG. 1 is a schematic diagram of a structure of a pixel circuit provided by embodiments of the present disclosure.

FIG. 2 is a schematic diagram of a structure of a pixel circuit provided by embodiments of the present disclosure.

FIG. 3 is a timing diagram of some signals provided by embodiments of the present disclosure.

FIG. 4 is a flow diagram of a driving method provided by embodiments of the present disclosure.

FIG. 5 is a timing diagram of another signals provided by embodiments of the present disclosure.

FIG. 6 is a timing diagram of another signals provided by embodiments of the present disclosure.

FIG. 7 is a timing diagram of another signals provided by embodiments of the present disclosure.

FIG. 8 is a timing diagram of another signals provided by embodiments of the present disclosure.

FIG. 9 is a timing diagram of another signals provided by embodiments of the present disclosure.

FIG. 10 is a timing diagram of another signals provided by embodiments of the present disclosure.

FIG. 11 is a timing diagram of another signals provided by embodiments of the present disclosure.

FIG. 12 is another flow chart of a driving method provided by embodiments of the present disclosure.

FIG. 13 is a timing diagram of another signals provided by embodiments of the present disclosure.

FIG. 14 is a timing diagram of another signals provided by embodiments of the present disclosure.

FIG. 15 is a timing diagram of another signals provided by embodiments of the present disclosure.

FIG. 16 is a timing diagram of another signals provided by embodiments of the present disclosure.

FIG. 17 is a timing diagram of another signals provided by embodiments of the present disclosure.

FIG. 18 is a timing diagram of another signals provided by embodiments of the present disclosure.

FIG. 19 is a timing diagram of another signals provided by embodiments of the present disclosure.

FIG. 20 is a timing diagram of another signals provided by embodiments of the present disclosure.

FIG. 21 is a timing diagram of another signals provided by embodiments of the present disclosure.

FIG. 22 is a timing diagram of another signals provided by embodiments of the present disclosure.

FIG. 23A is a timing diagram of another signals provided by embodiments of the present disclosure.

FIG. 23B is a timing diagram of another signals provided by embodiments of the present disclosure.

FIG. 23C is a timing diagram of another signals provided by embodiments of the present disclosure.

FIG. 23D is a timing diagram of another signals provided by embodiments of the present disclosure.

FIG. 24 is a timing diagram of another signals provided by embodiments of the present disclosure.

FIG. 25 is a timing diagram of another signals provided by embodiments of the present disclosure.

FIG. 26 is a schematic diagram of a structure of a display apparatus provided by embodiments of the present disclosure.

FIG. 27 is a timing diagram of another signals provided by embodiments of the present disclosure.

FIG. 28 is a timing diagram of another signals provided by embodiments of the present disclosure.

FIG. 29 is a timing diagram of another signals provided by embodiments of the present disclosure.

FIG. 30 is a timing diagram of another signals provided by embodiments of the present disclosure.

FIG. 31 is a timing diagram of another signals provided by embodiments of the present disclosure.

FIG. 32 is a timing diagram of another signals provided by embodiments of the present disclosure.

FIG. 33 is a timing diagram of another signals provided by embodiments of the present disclosure.

FIG. 34 is a timing diagram of another signals provided by embodiments of the present disclosure.

### DETAILED DESCRIPTION

In order to make the purpose, technical solution and advantages of the embodiments of the present disclosure clearer, the technical solutions of the embodiments of the present disclosure will be clearly and completely described below in conjunction with the accompanying drawings of the embodiments of the present disclosure. Obviously, the embodiments described are some embodiments of the present disclosure, not all embodiments. And in the absence of conflict, the embodiments in the present disclosure and the features in the embodiments may be combined with each other. Based on the embodiments of the present disclosure described, all other embodiments obtained by a person skilled in the art without creative labor are within the protection scope of the present disclosure.

Unless otherwise defined, the technical or scientific terms used in the disclosure shall have the ordinary meaning understood by persons with general skill in the field to which the disclosure belongs. The terms “first”, “second” and similar expressions used in the disclosure do not indicate any order, number or importance, but only to distinguish the different components. Words such as “include” or “comprise” mean that the element or object preceding the word includes the element or object listed after the word and its equivalents, and does not exclude other elements or objects. Similar terms such as “connection” or “connecting” are not limited to physical or mechanical connections, but may include electrical connections, whether direct or indirect.

It should be noted that the dimensions and shapes of the figures in the drawings do not reflect the true proportions, and are intended to illustrate the contents of the disclosure. The same or similar designation at all times indicates the same or similar element or component with the same or similar function.

The embodiments of the disclosure provide a display apparatus including: a display panel; and the display panel includes a plurality of pixel units arranged in an array. Exemplarily, each pixel unit includes a plurality of sub-pixels. For example, a pixel unit can include a red sub-pixel, a green sub-pixel, and a blue sub-pixel, so that red, green, and blue can be mixed to achieve color display. Alternatively, a pixel unit can also include a red sub-pixel, a green sub-pixel, a blue sub-pixel, and a white sub-pixel, so that red, green, blue, and white can be mixed to achieve color display. Of course, in practical application, the luminous color of the sub-pixels in the pixel unit can be designed and determined according to the actual application environment, and is not limited here.

In the embodiments of the present disclosure, each sub-pixel includes a pixel circuit; and the pixel circuit includes a driving transistor and a light-emitting device, to drive the light-emitting device to emit light, so that the display panel realizes the function of screen display. Due to the process and device aging, a threshold voltage Vth of the driving transistor will be non-uniform, which will lead to the change of the current flowing through different light-emitting devices, resulting in uneven display brightness, which will affect the display effect of the whole image.

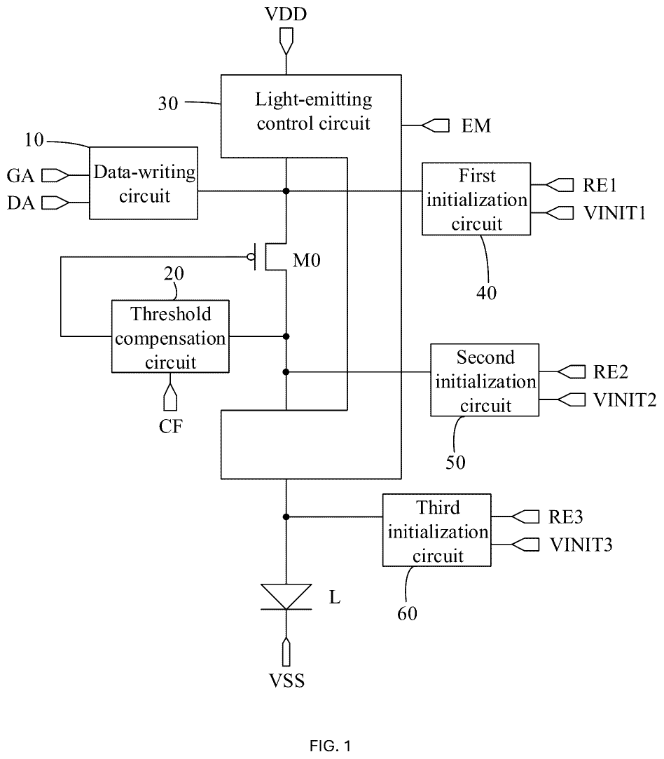

As shown in FIG. 1, the embodiments of the present disclosure provide a pixel circuit including: a light-emitting device L, a driving transistor M0, a data-writing circuit 10, a threshold compensation circuit 20, a light-emitting control circuit 30, a first initialization circuit 40, a second initialization circuit 50 and a third initialization circuit 60. The data-writing circuit 10 is coupled with a first electrode of the driving transistor M0. The threshold compensation circuit 20 is coupled with a gate of the driving transistor M0, a second electrode of the driving transistor M0 and a first power supply terminal VDD. The light-emitting control circuit 30 is coupled with the first electrode of the driving transistor M0, the second electrode of the driving transistor M0, the first power supply terminal VDD and the light-emitting device L. The first initialization circuit 40 is coupled with the first electrode of the driving transistor M0. The second initialization circuit 50 is coupled with the second electrode of the driving transistor M0. The third initialization circuit 60 is coupled with the light-emitting device L.

Exemplarily, the driving transistor M0 is configured to generate a driving current that drives the light-emitting device L to emit light based on a data voltage. The data-writing circuit 10 is configured to operate in response to an effective level of a first scanning signal terminal GA (e.g., a data voltage of a data signal terminal DA is provided to the first electrode of the driving transistor M0). The threshold compensation circuit 20 is configured to input a threshold voltage of the driving transistor M0 to the gate of the driving transistor M0 in response to an effective level of a compensation control signal terminal CF. The first initialization circuit 40 is configured to provide a signal from a first initialization signal terminal VINIT1 to the first electrode of the driving transistor M0 in response to an effective level of a first reset control signal terminal RE1. The second initialization circuit 50 is configured to provide a signal from a second initialization signal terminal VINIT2 to the second electrode of the driving transistor M0 in response to an effective level of the second reset control signal terminal RE2. The third initialization circuit 60 is configured to provide a signal of a third initialization signal terminal VINIT3 to the light-emitting device L in response to an effective level of a third reset control signal terminal RE3. The light-emitting control circuit 30 is configured to provide a driving current generated by the driving transistor M0 to the light-emitting device L in response to an effective level of a light-emitting control signal terminal EM to drive the light-emitting device L to emit light.

The embodiments of the present disclosure provide a pixel circuit which can avoid the influence of the threshold voltage drift of the driving transistor on the luminescence of the light-emitting device through mutual cooperation of the light-emitting device, the driving transistor, the data-writing circuit, the threshold compensation circuit, the light-emitting control circuit, the first initialization circuit, the second initialization circuit and the third initialization circuit.

The present disclosure is described in detail below in conjunction with specific embodiments. It should be noted that the embodiments of the disclosure are intended to better interpret the present disclosure, but do not limit the present disclosure.

In the embodiments of the present disclosure, as shown in FIG. 1, the driving transistor M0 may be set to an N-type transistor. The first electrode of the driving transistor M0 can be source, and the second electrode of the driving transistor M0 can be drain. Of course, the driving transistor M0 can also be set as a P-type transistor, which is not limited here.

In the embodiments of the present disclosure, as shown in FIG. 1, the second electrode of the driving transistor M0 is coupled with an anode of the light-emitting device L through the light-emitting control circuit 30, and a cathode of the light-emitting device L is coupled with a second power supply terminal VSS. Exemplarily, the light-emitting device L can include: organic light emitting diode (OLED), quantum dot light emitting diodes (QLED), micro light emitting diode (Micro LED), and mini light emitting diode (Mini LED). Exemplarily, the light-emitting device L may include an anode, a light-emitting layer, and a cathode arranged in a stacked arrangement. Further, the light-emitting layer can also include a hole injection layer, a hole transport layer, an electron transport layer, an electron injection layer and other film layers. In practical application, the specific structure of the light-emitting device L can be designed and determined according to the actual application environment, which is not limited here.

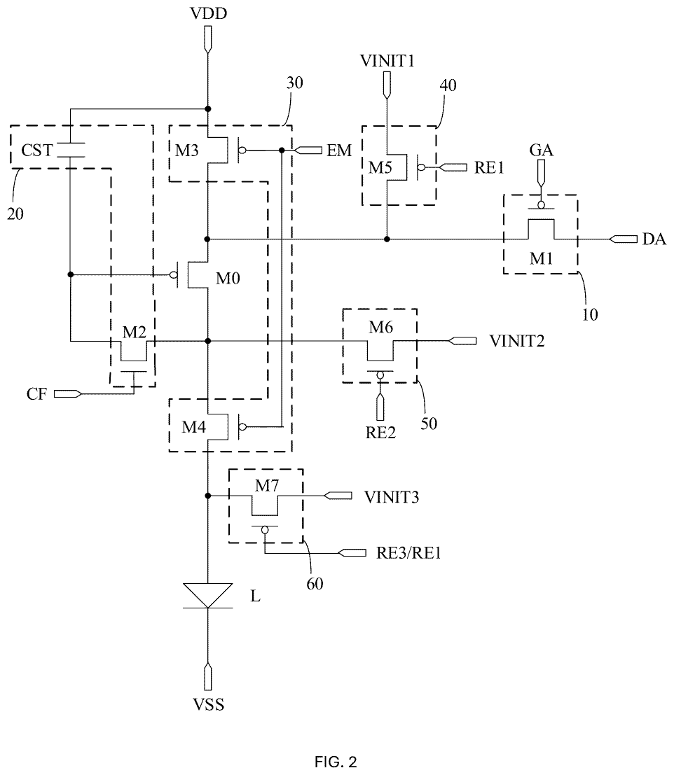

In some embodiments of the present disclosure, as shown in FIG. 2, the data-writing circuit 10 may include: a first transistor M1. The gate of the first transistor M1 is coupled with the first scanning signal terminal GA, the first electrode of the first transistor M1 is coupled with the data signal terminal DA, and the second electrode of the first transistor M1 is coupled with the first electrode of the driving transistor M0.

Exemplarily, the first transistor M1 can be turned on under the control of an effective level of a scanning signal ga of the first scanning signal terminal GA and can be turned off under the control of an invalid level of the scanning signal ga. Optionally, the first transistor M1 can be an N-type transistor, so the effective level of the scanning signal ga is high level, and the invalid level of the scanning signal ga is low level. Alternatively, the first transistor M1 can also be a P-type transistor, the effective level of the scanning signal ga is low level, and the invalid level of the scanning signal ga is high level.

In some embodiments of the present disclosure, as shown in FIG. 2, the threshold compensation circuit 20 may include: a second transistor M2 and a storage capacitor CST. A gate of the second transistor M2 is coupled with the compensation control signal terminal CF, a first electrode of the second transistor M2 is coupled with the gate of the driving transistor M0, a second electrode of the second transistor M2 is coupled with the second electrode of the driving transistor M0. The first electrode plate of the storage capacitor CST is coupled with the gate of the driving transistor M0, and the second electrode plate of the storage capacitor CST is coupled with the first power supply terminal VDD.

Exemplarily, the second transistor M2 can be turned on under the control of an effective level of a compensation control signal cf of the compensation control signal terminal CF and can be turned off under the control of an invalid level of the compensation control signal cf. Optionally, the second transistor M2 can be an N-type transistor, so that the effective level of the compensation control signal cf is high level, and the invalid level of the compensation control signal cf is low level. Alternatively, the second transistor M2 can also be a P-type transistor, the effective level of the compensation control signal cf is low level, and the invalid level of the compensation control signal cf is high level.

In some embodiments of the present disclosure, as shown in FIG. 2, the light-emitting control circuit 30 includes: a third transistor M3 and a fourth transistor M4. A gate of the third transistor M3 is coupled with the light-emitting control signal terminal EM, a first electrode of the third transistor M3 is coupled with the first power supply terminal VDD, a second electrode of the third transistor M3 is coupled with the first electrode of the driving transistor M0. A gate of the fourth transistor M4 is coupled with the light-emitting control signal terminal EM, a first electrode of the fourth transistor M4 is coupled with the second electrode of the driving transistor M0, and a second electrode of the fourth transistor M4 is coupled with the light-emitting device L.

Exemplarily, the third transistor M3 can be turned on under the control of an effective level of a light-emitting control signal em of the light-emitting control signal terminal EM and can be turned off under the control of an invalid level of the light-emitting control signal em. Optionally, the third transistor M3 can be an N-type transistor, so the effective level of the light-emitting control signal em is high level, and the invalid level of the light-emitting control signal em is low level. Alternatively, the third transistor M3 can also be a P-type transistor, the effective level of the light-emitting control signal em is low level, and the invalid level of the light-emitting control signal em is high level.

Exemplarily, the fourth transistor M4 can be turned on under the control of the effective level of the light-emitting control signal em of the light-emitting control signal terminal EM and can be turned off under the control of the invalid level of the light-emitting control signal em. Optionally, the fourth transistor M4 can be an N-type transistor, so the effective level of the light-emitting control signal em is high level, and the invalid level of the light-emitting control signal em is low level. Alternatively, the fourth transistor M4 can also be a P-type transistor, so the effective level of the light-emitting control signal em is low level, and the invalid level of the light-emitting control signal em is high level.

In some embodiments of the present disclosure, as shown in FIG. 2, the first initialization circuit 40 includes a fifth transistor M5. A gate of the fifth transistor M5 is coupled with the first reset control signal terminal RE1, a first electrode of the fifth transistor M5 is coupled with the first initialization signal terminal VINIT1, and a second electrode of the fifth transistor M5 is coupled with the first electrode of the driving transistor M0.

Exemplarily, the fifth transistor M5 can be turned on under the control of an effective level of a first reset control signal of the first reset control signal terminal RE1 and can be turned off under the control of an invalid level of the first reset control signal. Optionally, the fifth transistor M5 can be an N-type transistor, so that the effective level of the first reset control signal is high level, and the invalid level of the first reset control signal is low level. Alternatively, the fifth transistor M5 can also be a P-type transistor, the effective level of the first reset control signal is low level, and the invalid level of the first reset control signal is high level.

In some embodiments of the present disclosure, as shown in FIG. 2, the second initialization circuit 50 includes a sixth transistor M6. A gate of the sixth transistor M6 is coupled with a second reset control signal terminal RE2, a first electrode of the sixth transistor M6 is coupled with a second initialization signal terminal VINIT2, and a second electrode of the sixth transistor M6 is coupled with the second electrode of the driving transistor M0.

Exemplarily, the sixth transistor M6 can be turned on under the control of the effective level of the second reset control signal of the second reset control signal terminal RE2 and can be turned off under the control of the invalid level of the second reset control signal. Optionally, the sixth transistor M6 can be an N-type transistor, so that the effective level of the second reset control signal is high level, and the invalid level of the second reset control signal is low level. Alternatively, the sixth transistor M6 can also be a P-type transistor, the effective level of the second reset control signal is low level, and the invalid level of the second reset control signal is high level.

In some embodiments of the present disclosure, as shown in FIG. 2, the third initialization circuit 60 includes a seventh transistor M7. A gate of the seventh transistor M7 is coupled with a third reset control signal terminal RE3, a first electrode of the seventh transistor M7 is coupled with a third initialization signal terminal VINIT3, and a second electrode of the seventh transistor M7 is coupled with the light-emitting device L.

Exemplarily, the seventh transistor M7 can be turned on under the control of the effective level of the third reset control signal of the third reset control signal terminal RE3 and can be turned off under the control of the invalid level of the third reset control signal. Optionally, the seventh transistor M7 can be an N-type transistor, so that the effective level of the third reset control signal is high level, and the invalid level of the third reset control signal is low level. Alternatively, the seventh transistor M7 can also be a P-type transistor, so that the effective level of the third reset control signal is low level, and the invalid level of the third reset control signal is high level.

Exemplarily, the first electrode of the transistors described above can be source, and the second electrode can be drain. Alternatively, the first electrode is drain and the second electrode is source. No limitation is made herein.

Generally, the transistor using low-temperature poly-silicon (LTPS) material as an active layer has high mobility, can be made thinner, smaller, and lower power consumption, etc. In the specific implementation, the material of the active layer of at least one transistor can be set as a low-temperature poly-silicon material. In this way, the above transistors can be set as LTPS-type transistors, so that the pixel circuit can achieve high mobility, and can be made thinner, smaller, and lower power consumption.

Generally, the leakage current of the transistor using a metal oxide semiconductor material as an active layer is small, so in order to reduce the leakage current, in some embodiments of the present disclosure, the material of the active layer of at least one transistor can also be made to include a metal oxide semiconductor material, for example, indium gallium zinc oxide (IGZO). Of course, it can also be other metal oxide semiconductor materials, which is not limited herein. This allows the above transistors to be set as oxide thin film transistors to reduce the leakage current of the pixel circuit.

Exemplarily, all the transistors can be set to LTPS-type transistors.

Alternatively, all the transistors can be set to oxide-type transistors.

Alternatively, some of the transistors can be set to oxide-type transistors and the rest of transistors can be set to LTPS-type transistors. For example, as shown in FIG. 2, the second transistor M2 is an N-type oxide-type transistor, and the rest of transistors are set to P-type LTPS-type transistors, so that the pixel circuit can realize the LTPO pixel circuit, improving the performance of the pixel circuit, and improving the display effect.

Currently, the display panel can support multiple driving modes with multiple refresh rates (e.g., 1 Hz, 10 Hz, 30 Hz, 60 Hz, 120 Hz). In some static images, the display panel is usually driven at a lower refresh rate (e.g., 60 Hz) to reduce power consumption. In addition, different refresh rates are used to drive the display panel to work in the driving mode, which can use a higher refresh rate (such as 120 Hz) to drive to improve the display effect when the dynamic picture display is displayed, and can use a lower refresh rate (e.g., 60 Hz) to drive to reduce power consumption when the static picture is displayed. However, when the static picture is displayed, due to the lower refresh rate, the hysteresis effect of the driving transistor can easily lead to low grayscale flicker when switching between different refresh rates or when maintaining and refreshing sub-frames when driving at the lower refresh rate, which affects the display effect of products.

In order to improve the afterimage and hysteresis and realize different refresh frequency drives, as shown in FIG. 2, the first electrode of the driving transistor M0 is initialized by setting the third transistor M3 and the first initialization signal of the first initialization signal terminal VINIT1. However, the first initialization voltage of the first initialization signal is usually the voltage of a static fixed voltage value, and the first initialization voltage is still a voltage with a higher voltage value, and after the pixel circuit works for a long time, the bias of the driving transistor M0 is in the same state, and the bias of the driving transistor M0 in the same direction is easy to occur. In this way, after the pixel circuit is operated for a long time, the characteristics of the driving transistor M0 will change.

In order to improve the characteristic stability of the driving transistor, in the embodiments of the present disclosure, the data-writing circuit can provide the data voltage of the data signal terminal to the first electrode of the driving transistor in response to a plurality of effective levels of the first scanning signal terminal. In addition, in one data refresh phase, the scanning signal of the first scanning signal terminal has multiple effective levels that occur at intervals with each other, and the light-emitting control signal of the light-emitting control signal terminal has a time period with an invalid level and a time period with an effective level. In one data refresh phase, the time period of the invalid level of the light-emitting control signal terminal includes a time period for the effective level of the compensation control signal terminal and a time period for a plurality of effective levels of the first scanning signal terminal, and the plurality of effective levels of the first scanning signal terminal include at least one first effective level and at least one second effective level, and the time period for the effective level of the compensation control signal terminal includes a time period for the first effective level.

In the pixel circuit provided in the embodiments of the present disclosure, the threshold compensation can be realized through the data voltage input by the data-writing circuit at the first effective level of the first scanning signal terminal. The data voltage input at the second effective level of the first scanning signal terminal is only input to the first electrode of the driving transistor, so that the voltage of the first electrode of the driving transistor is the data voltage at this moment, so that the first electrode of the driving transistor is biased by the data voltage. In addition, due to the different data voltages of different gray scales, the bias voltage of the first electrode of the driving transistor cannot be the same bias voltage through the change of the data voltage while biasing the first electrode of the driving transistor, so that the bias state of the first electrode of the driving transistor changes with the change of the data voltage, so that the drift of the characteristics of the driving transistor caused by maintaining the bias of the same time and voltage for a long time is improved, and the characteristic stability of the driving transistor is improved.

In the embodiments of the present disclosure, the first scanning signal terminal may have one first effective level. Alternatively, the first scanning signal terminal can also have two first effective levels. Alternatively, the first scanning signal terminal can have three or more first effective levels. In practice, the number of first effective levels can be determined according to the needs of the application, which is not limited here.

In the embodiments of the present disclosure, the first scanning signal terminal may have one second effective level. Alternatively, the first scanning signal terminal can also have two second effective levels. Alternatively, the first scanning signal terminal can have three or more second effective levels. In practice, the number of second effective levels can be determined according to the needs of the application, which is not limited here.

In the embodiments of the present disclosure, a functional circuit in the pixel circuit may include a data-writing circuit, and a second scanning signal terminal may include a first scanning signal terminal. In addition, the seventh effective level of the second scanning signal terminal may include the first effective level of the first scanning signal terminal, and the eighth effective level of the second scanning signal terminal may include the second effective level of the first scanning signal terminal.

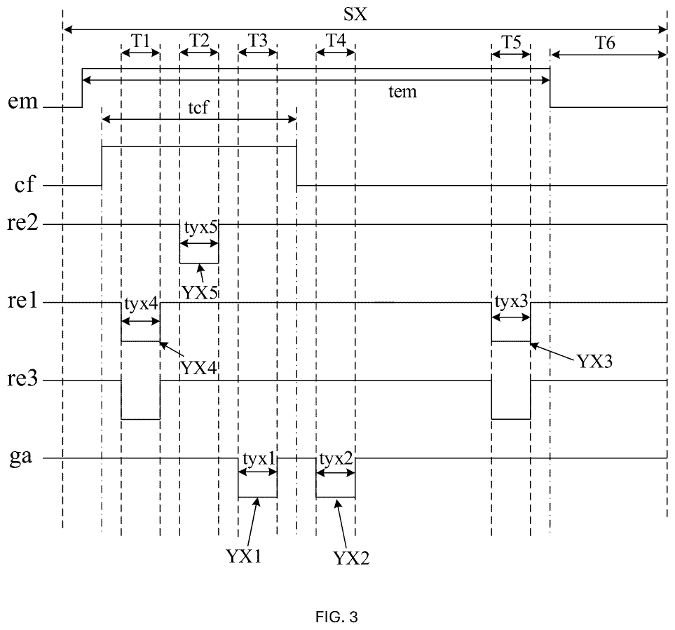

In some embodiments, the structure of the pixel circuit shown in FIG. 2 is used as an example, and the corresponding signal timing diagram is shown in FIG. 3. As shown in FIG. 3, SX represents a data refresh phase SX, em represents a light-emitting control signal of a light-emitting control signal terminal EM, cf represents a compensation control signal of a compensation control signal terminal CF, ga represents a scanning signal of a first scanning signal terminal GA, tem represents a time period of an invalid level of a light-emitting control signal em, tcf represents a time period of an effective level of a compensation control signal cf, tyx1 represents a time period of a first effective level YX1 of a scanning signal ga, and tyx2 represents a time period of a second effective level YX2 of a scanning signal ga. The scanning signal has a first effective level YX1 and a second effective level YX2, and there is an interval between the first effective level YX1 and the second effective level YX2. In addition, the time period tem of the invalid level (e.g., high level) of the light-emitting control signal em includes the time period tcf of the effective level (e.g., high level) of the compensation control signal cf and the time period tyx1 of the first effective level YX1 (e.g., low level) of the scanning signal ga tyx1 and the time period tyx2 of the second effective level YX2 (e.g., low level). In addition, the time period tcf of the effective level (e.g., high level) of the compensation control signal cf includes the time period tyx1 of the first effective level YX1 (e.g., low level), and the time period tcf of the effective level (e.g., high level) of the compensation control signal cf does not include the time period tyx2 of the second effective level YX2 (e.g., low level).

In some embodiments of the present disclosure, in one data refresh phase, a time period of at least one second effective level in at least one second effective level occurs after the time period of the effective level of the compensation control signal terminal. Exemplarily, as shown in FIG. 3, in one data refresh phase SX, it is possible to make the time period tyx2 of the second effective level YX2 (e.g., low level) appear after the time period tcf of the effective level (e.g., high level) of the compensation control signal cf.

In the embodiments of the present disclosure, in one data refresh phase, the time period of the invalid level of the light-emitting control signal terminal further includes the time period of the effective level of the first reset control signal terminal. The time period of the effective level of the first reset control signal terminal does not overlap with the time period of multiple effective levels of the first scanning signal terminal. Exemplarily, as shown in FIG. 3, re1 represents the first reset control signal of the first reset control signal terminal RE1. The time period tem of the invalid level (e.g., high level) of the light-emitting control signal em further includes the time period of the effective level (e.g., low level) of the first reset control signal re1, and the time period of the effective level (e.g., low level) of the first reset control signal re1 does not overlap with the time period tyx1 of the first effective level YX1 and the time period tyx2 of the second effective level YX2 in the scanning signal ga.

In the embodiments of the present disclosure, in one data refresh phase, the effective level of the first reset control signal terminal includes at least one third effective level, and the time period of at least one third effective level appears after the time period of multiple effective levels of the first scanning signal terminal. Exemplarily, as shown in FIG. 3, in one data refresh phase SX, the effective level (e.g., low level) of the first reset control signal re1 includes one third effective level YX3, and the time period tyx3 of the third effective level YX3 (e.g., low level) occurs after the time period (e.g., the time period tyx2 of the second effective level YX2) of multiple effective levels (e.g., low level) of the scanning signal ga. Alternatively, in one data refresh phase SX, the effective level of the first reset control signal can include two, three, or more third effective levels, and the time period of all the third effective levels occurs after the time period of all the effective levels of the scanning signal.

In the embodiments of the disclosure, in one data refresh phase, the effective level of the first reset control signal terminal includes at least one fourth effective level. The time period of the effective level of the compensation control signal terminal includes the time period of the fourth effective level, and the time period of the fourth effective level appears before the time period of the first effective level of the first scanning signal terminal. Exemplarily, as shown in FIG. 3, in one data refresh phase SX, the effective level (e.g., low level) of the first reset control signal re1 includes a fourth effective level, the time period tcf of the effective level (e.g., high level) of the compensation control signal cf includes the time period tyx4 of the fourth effective level YX4 (e.g., low level), and the time period tyx4 of the fourth effective level YX4 (e.g., low level) occurs before the time period tyx1 of the first effective level YX1 (e.g., low level) of the scanning signal ga. Alternatively, in one data refresh phase, the effective level of the first reset control signal may include two, three, or more fourth effective levels, and the time period of the effective level of the compensation control signal cf includes the time period of all the fourth effective levels, and the time period of all the fourth effective levels occurs before the time period of the first effective level of the scanning signal ga.

For example, the functional circuit may include the first initialization circuit, and the second scanning signal terminal may include the first reset control signal terminal. In addition, the seventh effective level of the second scanning signal terminal may include the fourth effective level of the first reset control signal terminal, and the eighth effective level of the second scanning signal terminal may include the third effective level of the first reset control signal terminal.

In the embodiments of the present disclosure, in one data refresh phase, the time period of the invalid level of the light-emitting control signal terminal includes the time period of the effective level of the second reset control signal terminal. The time period of the effective level of the second reset control signal terminal does not overlap with the time period of multiple effective levels in the first scanning signal terminal. Exemplarily, as shown in FIG. 3, re2 represents the second reset control signal of the second reset control signal terminal RE2. In one data refresh phase SX, the time period tem of the invalid level (e.g., high level) of the light-emitting control signal em includes the time period of the effective level (e.g., low level) of the second reset control signal re2, and the time period of the effective level (e.g., low level) of the second reset control signal re2 does not overlap with the time period of multiple effective levels (e.g., low level) of the scanning signal ga.

In the embodiments of the present disclosure, the effective level of the second reset control signal terminal includes at least one fifth effective level. In addition, in one data refresh phase, the time period of the effective level of the compensation control signal terminal includes a time period(s) of at least one fifth effective level, and the time period of at least one fifth effective level occurs before the time period of the effective level of the first scanning signal terminal. Exemplarily, as shown in FIG. 3, the effective level of the second reset control signal includes one fifth effective level, and in one data refresh phase SX, the time period of the effective level (e.g., low level) of the compensation control signal cf includes the time period tyx5 of the fifth effective level YX5 (e.g., low level), and the time period tyx5 of the fifth effective level YX5 (e.g., low level) occurs before the time period tyx1 of the first effective level YX1 (e.g., low level) of the scanning signal ga. Alternatively, the effective level of the second reset control signal includes two, three, or more fifth effective levels, and in one data refresh phase, the time period of the effective level of the compensation control signal cf includes the time period of all the fifth effective levels, and the time period of all the fifth effective levels occurs before the time period of the first effective level of the scanning signal ga.

In the embodiments of the disclosure, in one data refresh phase, the time period of the fifth effective level appears after the time period of the fourth effective level of the first reset control signal terminal. Exemplarily, as shown in FIG. 3, in one data refresh phase SX, the time period tyx5 of the fifth effective level YX5 (e.g., low level) appears after the time period tyx4 of all the fourth effective levels YX4 (e.g., low level) of the first reset control signal re1. Alternatively, the effective level of the second reset control signal includes two, three, or more fifth effective levels, in one data refresh phase, the time period for all the fifth effective levels occurs after the time period of all the fourth effective levels of the first reset control signal.

In the embodiments of the present disclosure, the timing sequence of the third reset control signal of the third reset control signal terminal may be the same as the timing sequence of the first reset control signal of the first reset control signal terminal. Exemplarily, as shown in FIG. 3, re3 represents the third reset control signal, the timing sequence of the third reset control signal re3 is the same as the timing sequence of the first reset control signal re1.

In the embodiments of the present disclosure, the third reset control signal terminal RE3 and the first reset control signal terminal RE1 may be the same signal terminal. Exemplarily, as shown in FIG. 3, the gate of the seventh transistor M7 can also be coupled directly to the first reset control signal terminal RE1, which reduces the number of signal wrings and makes wiring easier.

In the embodiments of the present disclosure, the third reset control signal terminal and the compensation control signal terminal may also be the same signal terminal. Alternatively, the third reset control signal terminal and the first scanning signal terminal may be the same signal terminal. Alternatively, the third reset control signal terminal and the second reset control signal terminal may be the same signal terminal.

In the embodiments of the present disclosure, the first initialization signal terminal can be loaded with a voltage with a higher voltage value. In addition, the voltage value of the first initialization signal terminal can be determined according to the needs of the actual application, and is not limited here.

In the embodiments of the present disclosure, the third initialization signal terminal and the second initialization signal terminal may be independent of each other in signals. In this way, the third initialization signal terminal and the second initialization signal terminal can be loaded with different voltage values respectively, and of course, the third initialization signal terminal and the second initialization signal terminal can be loaded with the same voltage value respectively, which is not limited here.

In the embodiments of the present disclosure, at least two of the third initialization signal terminal, the second initialization signal terminal and the second power supply terminal are the same signal terminal, which reduces the number of signal wirings and makes wiring easier.

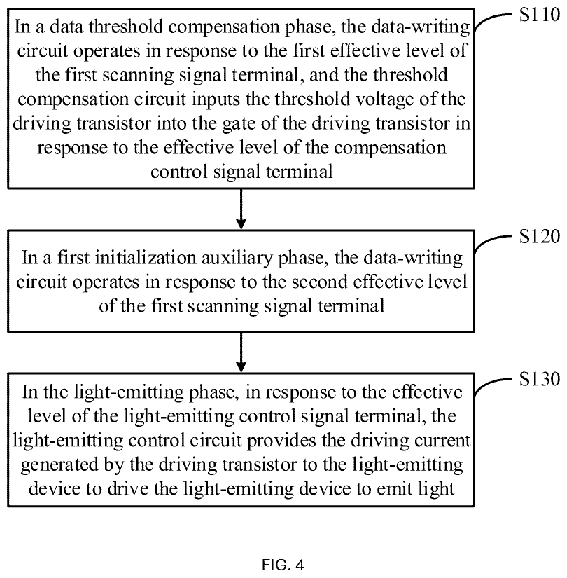

The embodiments of the disclosure further provide a driving method for a pixel circuit, including a data refresh phase. Exemplarily, as shown in FIG. 4, the data refresh phase includes the following steps:
S110, in a data threshold compensation phase, the data-writing circuit operates in response to the first effective level of the first scanning signal terminal, and the threshold compensation circuit inputs the threshold voltage of the driving transistor into the gate of the driving transistor in response to the effective level of the compensation control signal terminal;
S120, in a first initialization auxiliary phase, the data-writing circuit operates in response to the second effective level of the first scanning signal terminal;
S130, in the light-emitting phase, in response to the effective level of the light-emitting control signal terminal, the light-emitting control circuit provides the driving current generated by the driving transistor to the light-emitting device to drive the light-emitting device to emit light.

In the embodiments of the present disclosure, before the data threshold compensation phase, the method further includes a first initialization phase. In the first initialization phase, the first initialization circuit provides the signal of the first initialization signal terminal to the first electrode of the driving transistor in response to the fourth effective level of the first reset control signal terminal.

In the embodiments of the present disclosure, between the first initialization phase and the data threshold compensation phase, the method further includes a second initialization phase. In the second initialization phase, the second initialization circuit is configured to provide the signal of the second initialization signal terminal to the second electrode of the driving transistor in response to the fifth effective level of the second reset control signal terminal.

Optionally, in the first initialization phase, the method further includes: the third initialization circuit provides the signal of the third initialization signal terminal to the light-emitting device in response to the effective level of the third reset control signal terminal.

Optionally, in the second initialization phase, the method further includes: the third initialization circuit provides the signal of the third initialization signal terminal to the light-emitting device in response to the effective level of the third reset control signal terminal.

In the embodiments of the present disclosure, between the first initialization auxiliary phase and the light-emitting phase, the method further includes: the third initialization auxiliary phase. In the third initialization auxiliary phase, the first initialization circuit provides the signal of the first initialization signal terminal to the first electrode of the driving transistor in response to the third effective level of the first reset control signal terminal.

Optionally, in the third initialization auxiliary phase, the method further includes: the third initialization circuit provides the signal of the third initialization signal terminal to the light-emitting device in response to the effective level of the third reset control signal terminal.

The operation of the pixel circuit provided in the embodiments of the present disclosure is described below, taking the pixel circuit shown in FIG. 2 as an example, combined with the signal sequence diagram shown in FIG. 3. Among them, the data refresh phase SX can include: the first initialization phase T1, the second initialization phase T2, the data threshold compensation phase T3, the first initialization auxiliary phase T4, the third initialization auxiliary phase T5, and the light-emitting phase T6.

In the first initialization phase T1, the first transistor M1 is turned off under the control of the high level of the scanning signal ga, the second transistor M2 is turned on under the control of the high level of the compensation control signal cf, the third transistor M3 and the fourth transistor M4 are turned off under the control of the high level of the light-emitting control signal em, the fifth transistor M5 is turned on under the control of the low level of the first reset control signal re1, the sixth transistor M6 is turned off under the control of the high level of the second reset control signal re2, and the seventh transistor M7 is turned on under the control of the low level of the third reset control signal re3.

The turned-on fifth transistor M5 provides the first initialization signal of the first initialization signal terminal VINIT1 to the first electrode of the driving transistor M0, so that the voltage Vs of the first electrode of the driving transistor M0 is the voltage Vinit1 of the first initialization signal, that is, Vs=Vinit1, and the first electrode of the driving transistor M0 is initialized. The turned-on seventh transistor M7 provides the third initialization signal of the third initialization signal terminal VINIT3 to the anode of the light-emitting device L, and initializes the anode of the light-emitting device L. The turned-on second transistor M2 conducts the gate and second electrode of the driving transistor M0.

In the second initialization phase T2, the first transistor M1 is turned off under the control of the high level of the scanning signal ga, the second transistor M2 is turned on under the control of the high level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned on under the control of the low level of the second reset control signal re2, and the seventh transistor M7 is turned off under the control of the high level of the third reset control signal re3.

The turned-on sixth transistor M6 provides the second initialization signal of the second initialization signal terminal VINIT2 to the second electrode of the driving transistor M0, so that the voltage Vd of the second electrode of the driving transistor M0 is the voltage Vinit2 of the second initialization signal, that is, Vd=Vinit2, and the second electrode of the driving transistor M0 is initialized. The turned-on second transistor M2 conducts the gate and the second electrode of driving transistor M0, so that the voltage Vg of the gate of the driving transistor M0 is the voltage Vinit2 of the second initialization signal, that is, Vg=Vinit2, and the gate of the driving transistor M0 is initialized.

In the data threshold compensation phase T3, the first transistor M1 is turned on under the control of the low level of the scanning signal ga, the second transistor M2 is turned on under the control of the high level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda of the data signal terminal DA to the first electrode of the driving transistor M0, so that Vs=Vda. The turned-on second transistor M2 conducts the gate and the second electrode of the driving transistor M0, so that the driving transistor M0 forms a diode connection mode, and Vg=Vda+Vth, and the driving transistor M0 is turned off. The data voltage Vda is the grayscale voltage to be displayed by the light-emitting device L.

In the first initialization auxiliary phase T4, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda1 of the data signal terminal DA to the first electrode of the driving transistor M0, so that Vs=Vda1. The data voltage Vda1 is the grayscale voltage to be displayed by the light-emitting device L in other rows of sub-pixels. Since the second transistor M2 is turned off, the data voltage Vda1 does not affect the voltage of the gate of the driving transistor M0, and the voltage of the gate of the driving transistor M0 continues to remain Vda+Vth.

In addition, between the beginning of the first initialization auxiliary phase T4 and the beginning of the third initialization auxiliary phase T5, the voltage of the first electrode of the driving transistor M0 is Vda1, and the first electrode of the driving transistor M0 is biased by Vda1. Due to the different data voltages of different gray scales, the bias voltage of the first electrode of the driving transistor M0 cannot be the same bias voltage through the change of the data voltage when the first electrode of the driving transistor M0 is biased, so that the bias state of the first electrode of the driving transistor M0 changes with the change of the data voltage, so that the drift of the characteristic of the driving transistor M0 caused by maintaining the bias of the same time and voltage for a long time is improved, and the characteristic stability of the driving transistor M0 is improved.

In the third initialization auxiliary phase T5, the first transistor M1 is turned off under the control of the high level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned on under the control of the low level of the first reset control signal re1, the sixth transistor M6 is turned off under the control of the high level of the second reset control signal re2, and the seventh transistor M7 is turned on under the control of the low level of the third reset control signal re3.

The turned-on fifth transistor M5 provides the first initialization signal of the first initialization signal terminal VINIT1 to the first electrode of the driving transistor M0, so that the voltage Vs of the first electrode of the driving transistor M0 becomes the voltage Vinit1 of the first initialization signal again, that is, Vs=Vinit1, and the Vs is unified into Vinit1 before driving the light-emitting device L to emit light. The turned-on seventh transistor M7 provides the third initialization signal of the third initialization signal terminal VINIT3 to the anode of the light-emitting device L, and initializes the anode of the light-emitting device L.

In the light-emitting phase T6, the first transistor M1 is turned off under the control of the high level of the scanning signal ga, the second transistor M2 is turned off under the control of the low level of the compensation control signal cf, the third transistor M3 and the fourth transistor M4 are turned on under the control of the low level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on third transistor M3 provides the voltage Vdd of the first power supply terminal VDD to the first electrode of the driving transistor M0, so that Vs=Vdd. The turned-on fourth transistor M4 conducts the second electrode of the driving transistor M0 and the anode of the light-emitting device L. In addition, Vg=Vda+Vth, then the driving transistor M0 is driven to generate the driving current IL, and IL=K[Vda−Vdd]², where K=½*μ*Cox*W/L, μ is the mobility of the driving transistor M0, Cox is the gate insulation capacitance, and W/L is the channel width-to-length ratio of the driving transistor M0.

As can be seen from the above, the driving current IL is not related to the threshold voltage of the driving transistor M0, so the pixel circuit can solve the problem of uneven display caused by the uneven threshold voltage compensation of the driving transistor M0, thereby improving the display effect.

In addition, between the beginning of the first initialization auxiliary phase T4 and the beginning of the third initialization auxiliary phase T5, the voltage of the first electrode of the driving transistor M0 is Vda1, and the first electrode of the driving transistor M0 is biased by Vda1. Due to different data voltages of different gray scales, the bias voltage of the first electrode of the driving transistor M0 cannot be the same bias voltage through the change of the data voltage when the first electrode of the driving transistor M0 is biased, so that the bias state of the first electrode of the driving transistor M0 changes with the change of the data voltage, so that the drift of the characteristic of the driving transistor M0 caused by maintaining the bias of the same time and voltage for a long time is improved, and the characteristic stability of the driving transistor M0 is improved.

The pixel circuits provided in the present disclosure can support a variety of different refresh rate drivers, such as 1 Hz, 10 Hz, 30 Hz, 60 Hz, 120 Hz, and so on. In this way, when the pixel circuit is driven by a higher refresh rate, it is conducive to the improvement of the effect of scenes such as games, further improving the luminous stability and improving the display effect of the display panel.

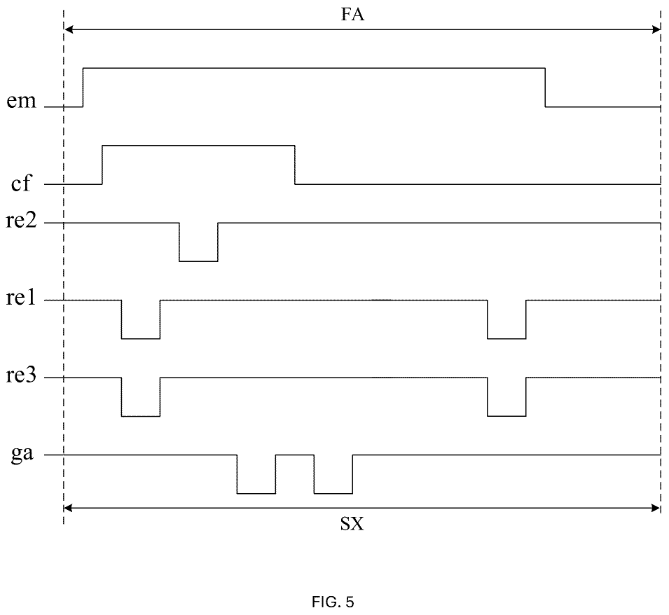

In the embodiments of the present disclosure, when a maximum refresh rate (e.g., 120 Hz) is used to drive the pixel circuit to operate, the operation of the pixel circuit in a display frame is the operation of the pixel circuit in a data refresh phase SX. For example, as shown in FIG. 5, when the pixel circuit is driven by the maximum refresh rate (e.g., 120 Hz), the operation of the pixel circuit in one display frame FA in FIG. 5 is the operation in the data refresh phase SX of the pixel circuit in FIG. 3.

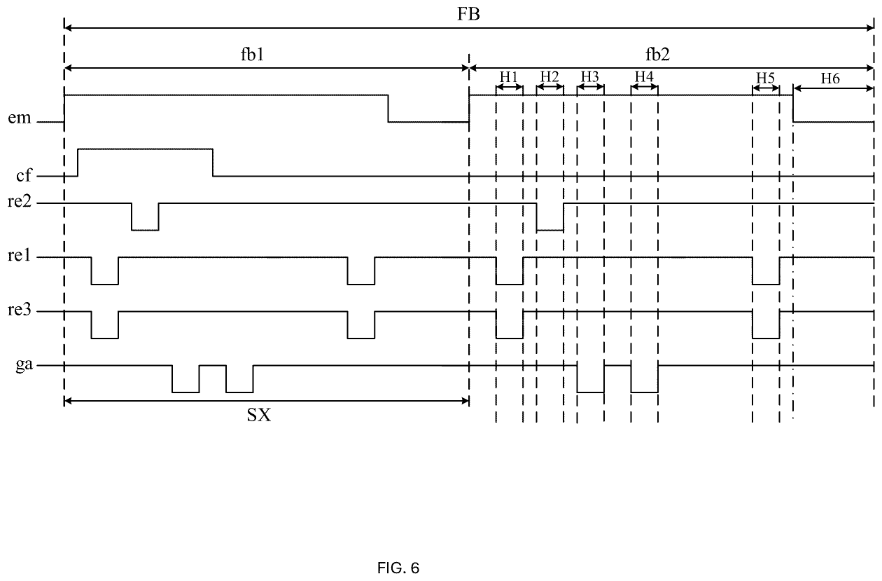

In the embodiments of the present disclosure, when adopting other refresh rate (e.g., 1 Hz, 30 Hz, 60 Hz) that are less than the maximum refresh rate, one display frame corresponding to the pixel circuit includes a plurality of successive display sub-frames, the first display sub-frame in the plurality of display sub-frames is defined as a refresh sub-frame fb1, the remaining display sub-frames are defined as maintaining sub-frame fb2, and the operation of the pixel circuit in a refresh sub-frame fb1 is the operation of the pixel circuit in a data refresh phase SX. For example, as shown in FIG. 6, the pixel circuit has a refresh sub-frame fb1 and a maintaining sub-frame fb2 in a display frame FB, and the operation of the pixel circuit in the refresh sub-frame fb1 in FIG. 6 is the operation of the pixel circuit in a data refresh phase SX in FIG. 3.

In some embodiments of the present disclosure, the compensation control signal terminal is an invalid level in the maintaining sub-frame. For example, as shown in FIG. 6, the compensation control signal cf is an invalid level (e.g., low level) in the maintaining sub-frame fb2.

In some embodiments of the present disclosure, the timing sequence of the light-emitting control signal terminal in the maintaining sub-frame is the same as the timing sequence of the light-emitting control signal terminal in the refresh sub-frame. For example, as shown in FIG. 6, the timing sequence of the light-emitting control signal em in the maintaining sub-frame fb2 is the same as the timing sequence of the light-emitting control signal em in the refresh sub-frame fb1.

In some embodiments of the present disclosure, the timing sequence of the first scanning signal terminal in the maintaining sub-frame is the same as the timing sequence of the first scanning signal terminal in the refresh sub-frame. For example, as shown in FIG. 6, the timing sequence of the scanning signal ga in the maintaining sub-frame fb2 is the same as the timing sequence of the scanning signal ga in the refresh sub-frame fb1.

In some embodiments of the present disclosure, the timing sequence of the first reset control signal terminal in at least one maintaining sub-frame is the same as the timing sequence of the first reset control signal terminal in the refresh sub-frame. For example, as shown in FIG. 6, the timing sequence of the first reset control signal re1 in each maintaining sub-frame fb2 is the same as the timing sequence of the first reset control signal re1 in the refresh sub-frame fb1.

In some other embodiments of the present disclosure, the timing sequence of the first reset control signal terminal in part of maintaining sub-frame is the same as the timing sequence of the first reset control signal terminal in the refresh sub-frame, and the number of effective levels of the first reset control signal terminal in the remaining part of maintaining sub-frames is less than the number of effective levels of the first reset control signal terminal in the refresh sub-frame.

In some other embodiments of the present disclosure, the timing sequence of the first reset control signal terminal in part of maintaining sub-frames is the same as the timing sequence of the first reset control signal terminal in the refresh sub-frame, and the first reset control signal terminal is an invalid level in the remaining part of maintaining sub-frames. For example, only in the maintaining sub-frame when the next display frame arrives, the timing sequence of the first reset control signal terminal is the same as the timing sequence of the first reset control signal terminal in the refresh sub-frame, and the first reset control signal terminal is an invalid level in the remaining part of maintaining sub-frames.

In some other embodiments of the present disclosure, the first reset control signal terminal may also be an invalid level in the maintaining sub-frame.

In some other embodiments of the present disclosure, the timing sequence of the second reset control signal terminal in at least one maintaining sub-frame is the same as the timing sequence of the second reset control signal terminal in the refresh sub-frame. For example, as shown in FIG. 6, the timing sequence of the second reset control signal re2 in each maintaining sub-frame fb2 is the same as the timing sequence of the second reset control signal re2 in the refresh sub-frame fb1.

In some other embodiments of the present disclosure, the timing sequence of the second reset control signal terminal in the part of maintaining sub-frames is the same as the timing sequence of the second reset control signal terminal in the refresh sub-frame, and the number of effective levels of the second reset control signal terminal in the remaining part of maintaining sub-frames is less than the number of effective levels of the second reset control signal terminal in the refresh sub-frame.

In some other embodiments of the present disclosure, the timing sequence of the second reset control signal terminal in the part of maintaining sub-frames is the same as the timing sequence of the second reset control signal terminal in the refresh sub-frame, and the second reset control signal terminal is an invalid level in the remaining part of maintaining sub-frames. For example, only in the maintaining sub-frame when the next display frame arrives, the timing sequence of the second reset control signal terminal is the same as the timing sequence of the second reset control signal terminal in the refresh sub-frame, and the second reset control signal terminal is an invalid level in the remaining part of maintaining sub-frames.

In some embodiments of the present disclosure, the timing sequence of the third reset control signal terminal in at least one maintaining sub-frame is the same as the timing sequence of the third reset control signal terminal in the refresh sub-frame. For example, as shown in FIG. 6, the timing sequence of the third reset control signal re3 in each maintaining sub-frame fb2 is the same as the timing sequence of the third reset control signal re3 in the refresh sub-frame fb1.

In some other embodiments of the present disclosure, the timing sequence of the third reset control signal terminal in the part of maintaining sub-frames is the same as the timing sequence of the third reset control signal terminal in the refresh sub-frame, and the number of effective levels of the third reset control signal terminal in the remaining part of maintaining sub-frames is less than the number of effective levels of the third reset control signal terminal in the refresh sub-frame.

In some other embodiments of the present disclosure, the timing sequence of the third reset control signal terminal in the part of maintaining sub-frames is the same as the timing sequence of the third reset control signal terminal in the refresh sub-frame, and the third reset control signal terminal is an invalid level in the remaining part of the maintaining sub-frames. For example, only in the maintaining sub-frame when the next display frame arrives, the timing sequence of the third reset control signal terminal is the same as the timing sequence of the third reset control signal terminal in the refresh sub-frame, and the third reset control signal terminal is an invalid level in the remaining part of the maintaining sub-frame.

For example, as shown in FIG. 6, when a pixel circuit is driven with a low refresh rate, e.g., at a 60 Hz refresh rate, the operation of the pixel circuit in the refresh sub-frame fb1 is the same as the operation of the pixel circuit in the data refresh phase SX. In the maintaining sub-frame fb2, there are H1, H2, H3, H4, H5, and H6 phases.

In the H1 phase, the second transistor M2 is turned off under the control of the low level of the compensation control signal cf, and the rest of the operation can be the same as the operation of the first initialization phase T1, which will not be repeated here.

In the H2 phase, the second transistor M2 is turned off under the control of the low level of the compensation control signal cf, and the rest of the operation can be the same as the operation of the second initialization phase T2, which will not be repeated here.

In the H3 phase, the second transistor M2 is turned off under the control of the low level of the compensation control signal cf, and the turned-on first transistor M1 provides the data voltage Vda2 of the data signal terminal DA to the first electrode of the driving transistor M0, so that Vs=Vda2. The data voltage Vda2 is the voltage of the grayscale to be displayed by the light-emitting device L in other sub-pixels. Since the second transistor M2 is turned off, the data voltage Vda2 does not affect the voltage of the gate of the driving transistor M0, and the gate of the driving transistor M0 continues to remain Vda+Vth. The rest of the operation can be the same as the operation of the second initialization phase T2, which will not be repeated here.

In the H4 phase, the operation can be the same as that of the first initialization auxiliary phase T4, which will not be repeated here.

In the H5 phase, the operation can be the same as that of the third initialization auxiliary phase T5, which will not be repeated here.

In the H6 phase, the operation can be the same as that of the light-emitting phase T6, which will not be repeated here.

In the maintaining sub-frame, the first electrode of the driving transistor is biased by the data voltage, and because the data voltages of different gray levels are different, the bias voltage of the first electrode of the driving transistor cannot be the same bias voltage through the change of the data voltage when the first electrode of the driving transistor is biased, so that the bias state of the first electrode of the driving transistor changes with the change of the data voltage, and then the problem of the drift of characteristics of the driving transistor caused by maintaining the bias of the same time and voltage for a long time is improved, and the characteristic stability of the driving transistor is improved.

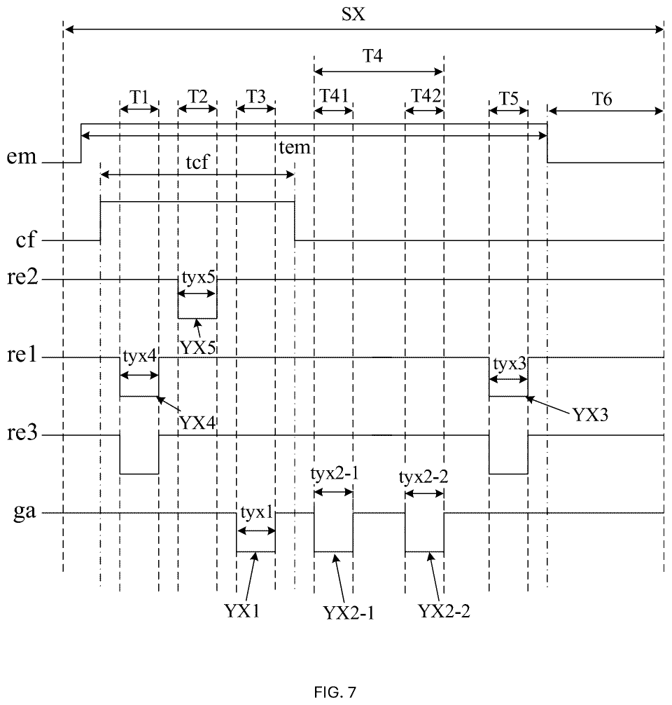

The embodiments of the present disclosure provide some signal sequence diagrams of the display panel, as shown in FIG. 7, and it is deformed for the embodiments in the above embodiments. The following only explains the differences between the present embodiments and the above embodiments, and its similarities are not repeated herein.

In some embodiments of the present disclosure, a plurality of effective levels in the first scanning signal terminal may also include two second effective levels. The time period of the two second effective levels occurs after the time period of the effective level of the compensation control signal terminal. For example, as shown in FIG. 7, SX represents a data refresh phase SX, em represents the light-emitting control signal of the light-emitting control signal terminal EM, cf represents the compensation control signal of the compensation control signal terminal CF, ga represents the scanning signal of the first scanning signal terminal GA, re1 represents the first reset control signal of the first reset control signal terminal RE1, re2 represents the second reset control signal of the second reset control signal terminal RE2, and re3 represents the third reset control signal of the third reset control signal terminal RE3.

The scanning signal has one first effective level and two second effective levels YX2-1 and YX2-2, and there is an interval time between the first effective level and the second effective level YX2-1, an interval time between the second effective level YX2-1 and the second effective level YX2-2, and an interval time between the first effective level and the second effective level YX2-2. In addition, the time period tem of the invalid level (e.g., high level) of the light-emitting control signal em includes the time period tcf of the effective level (e.g., high level) of the compensation control signal cf, the time period tyx1 of the first effective level YX1 of the scanning signal ga, the time period tyx2-1 of the second effective level YX2-1, and the time period tyx2-2 of the second effective level YX2-2. In addition, the time period tcf of the effective level (e.g., high level) of the compensation control signal cf includes the time period tyx1 of the first effective level YX1, while the time period tcf of the effective level (e.g., high level) of the compensation control signal cf does not include the time period tyx2-1 of the second effective level YX2-1 and the time period tyx2-2 of the second effective level YX2-2.

Further, in one data refresh phase SX, the time period tyx2-1 of the second effective level YX2-1 and the time period tyx2-2 of the second effective level YX2-2 can occur after the time period of the effective level of the compensation control signal cf.

Further, in one data refresh phase SX, the time period tyx2-1 of the second effective level YX2-1 and the time period tyx2-2 of the second effective level YX2-2 can occur before the third effective level of the first reset control signal.

Of course, in one data refresh phase, multiple effective levels of the first scanning signal terminal may include three or more second effective levels. Further, the time period of three or more second effective levels occurs after the time period of the effective level of the compensation control signal. In practice, the number of second effective levels that occur after the time period of the effective level of the compensation control signal can be determined according to the needs of the actual application environment, and is not limited here.

The operation of the pixel circuit provided in the embodiments of the present disclosure is described below, taking the pixel circuit shown in FIG. 2 as an example, combined with the signal sequence diagram shown in FIG. 7. The data refresh phase SX can include: the first initialization phase T1, the second initialization phase T2, the data threshold compensation phase T3, the first initialization auxiliary phase T4, the third initialization auxiliary phase T5, and the light-emitting phase T6. The first initialization phase T1, the second initialization phase T2, the data threshold compensation phase T3, the third initialization auxiliary phase T5 and the light-emitting phase T6 can refer to the described process in the above embodiments, and will not be repeated here.

Further, the first initialization auxiliary phase T4 includes a T41 phase and a T42 phase. In the T41 phase, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda1 of the data signal terminal DA to the first electrode of the driving transistor M0, so that Vs=Vda1. The data voltage Vda1 is the voltage of the grayscale to be displayed by the light-emitting device L in other rows of sub-pixels. Since the second transistor M2 is turned off, the data voltage Vda1 does not affect the voltage of the gate of the driving transistor M0, and the voltage of the gate of the driving transistor M0 continues to remain Vda+Vth.

In the T42 phase, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda2 of the data signal terminal DA to the first electrode of the driving transistor M0, so that Vs=Vda2. The data voltage Vda2 is the voltage of the grayscale to be displayed by the light-emitting device L in other rows of sub-pixels. Since the second transistor M2 is turned off, the data voltage Vda2 does not affect the voltage of the gate of the driving transistor M0, and the voltage of the gate of the driving transistor M0 continues to remain Vda+Vth.

Due to the different data voltages of different gray scales, the bias voltage of the first electrode of the driving transistor M0 cannot be the same bias voltage through the change of the data voltage while biasing the first electrode of the driving transistor M0 in the first initialization auxiliary phase T4, so that the bias state of the first electrode of the driving transistor M0 changes with the change of the data voltage, so that the drift of characteristic of the driving transistor M0 caused by maintaining the bias of the same time and voltage for a long time is improved, and the characteristic stability of the driving transistor M0 is improved.

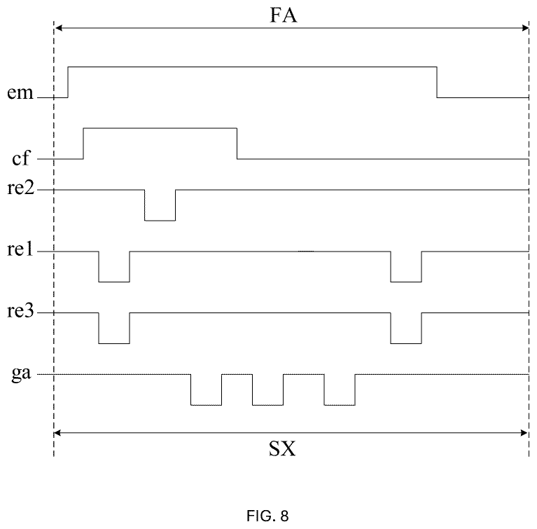

In the embodiments of the present disclosure, when the maximum refresh rate (e.g., 120 Hz) is used to drive the pixel circuit to operate, the operation of the pixel circuit in a display frame is the operation of the pixel circuit in a data refresh phase SX. For example, as shown in FIG. 8, when the pixel circuit is driven by the maximum refresh rate (e.g., 120 Hz), the operation of the pixel circuit in one display frame FA in FIG. 8 is the operation of the pixel circuit in the data refresh phase SX in FIG. 7.

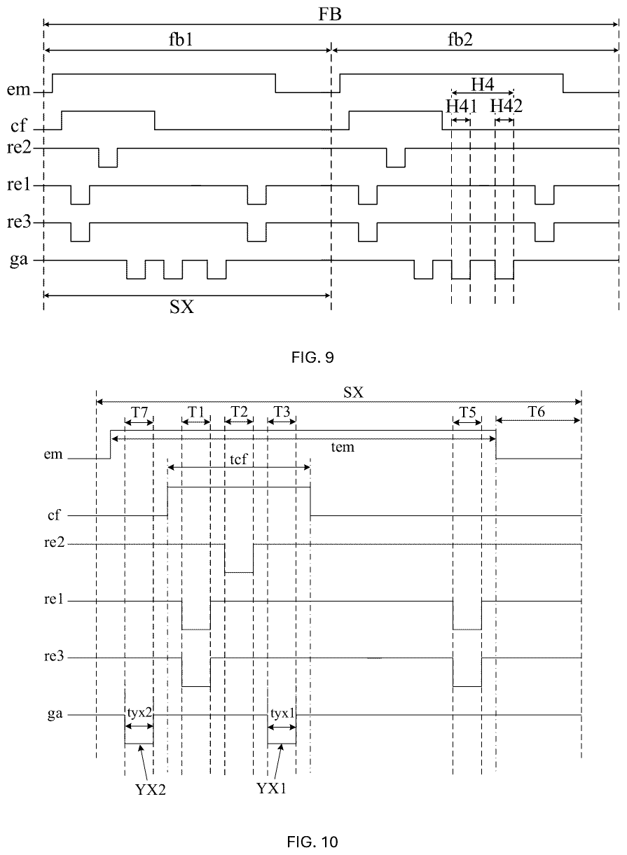

In the embodiments of the present disclosure, when adopting other refresh rates (e.g., 1 Hz, 30 Hz, 60 Hz) that are less than the maximum refresh rate, a display frame corresponding to the pixel circuit includes a plurality of successive display sub-frames. The first display sub-frame in the plurality of display sub-frames is defined as a refresh sub-frame fb1, the remaining display sub-frames are defined as maintaining sub-frame fb2. The operation of the pixel circuit in the refresh sub-frame fb1 is the operation of the pixel circuit in the data refresh phase SX. For example, as shown in FIG. 9, the pixel circuit includes a refresh sub-frame fb1 and a maintaining sub-frame fb2 in a display frame FB, where the operation of the pixel circuit in the refresh sub-frame fb1 in FIG. 9 is the operation of the pixel circuit in a data refresh phase SX in FIG. 7. In the maintaining sub-frame fb2, except for the H4 phase, in which the operation is different from the operation in the above embodiments, operations in other phases are the same as the operations in the above embodiments, and will not be repeated herein.

The H4 phase includes H41 and H42 phases. In the H41 phase, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda3 of the data signal terminal DA to the first electrode of the driving transistor M0, so that Vs=Vda3. The data voltage Vda3 is the voltage of the grayscale to be displayed by the light-emitting device L in other rows of sub-pixels. Since the second transistor M2 is turned off, the data voltage Vda3 does not affect the voltage of the gate of the driving transistor M0, and the voltage of the gate of the driving transistor M0 continues to be Vda+Vth.

In the H42 phase, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda4 of the data signal terminal DA to the first electrode of the driving transistor M0, so that Vs=Vda4. The data voltage Vda4 is the voltage of grayscale to be displayed by the light-emitting device L in other rows of sub-pixels. Since the second transistor M2 is turned off, the data voltage Vda4 does not affect the voltage of the gate of the driving transistor M0, and the voltage of the gate of the driving transistor M0 continues to be Vda+Vth.

The embodiments of the present disclosure provide some other signal sequence diagrams of the display panel, as shown in FIG. 10, which are deformed for the embodiments in the above embodiments. The following only explains the differences between the present embodiments and the above embodiments, and similarities between them are not repeated herein.

In some embodiments of the present disclosure, a plurality of effective levels in the first scanning signal terminal may include a second effective level. The time period of the second effective level occurs before the time period of the effective level of the compensation control signal terminal. For example, as shown in FIG. 10, SX represents a data refresh phase SX, em represents the light-emitting control signal of the light-emitting control signal terminal EM, cf represents the compensation control signal of the compensation control signal terminal CF, ga represents the scanning signal of the first scanning signal terminal GA, re1 represents the first reset control signal of the first reset control signal terminal RE1, re2 represents the second reset control signal of the second reset control signal terminal RE2, and re3 represents the third reset control signal of the third reset control signal terminal RE3. The time period tyx2 of the second effective level YX2 (e.g., low level) of the scanning signal ga occurs before the time period tcf of the effective level (e.g., high level) of the compensation control signal cf.

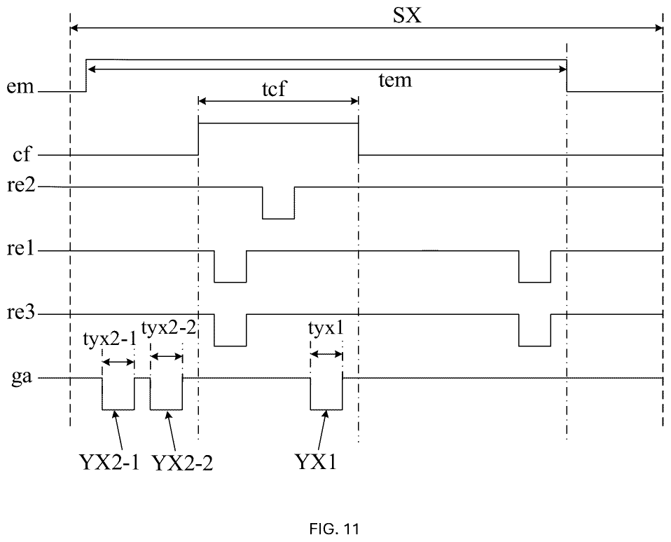

In some embodiments of the present disclosure, a plurality of effective levels in the first scanning signal terminal GA may include two second effective levels YX2-1 and YX2-2. The time period tyx2-1 of the second effective level YX2-1 and the time period tyx2-1 of the second effective level YX2-1 both occurs before the time period tcf of the effective level of the compensation control signal terminal CF. For example, as shown in FIG. 11, SX represents a data refresh phase SX, em represents the light-emitting control signal of the light-emitting control signal terminal EM, cf represents the compensation control signal of the compensation control signal terminal CF, ga represents the scanning signal of the first scanning signal terminal GA, re1 represents the first reset control signal of the first reset control signal terminal RE1, re2 represents the second reset control signal of the second reset control signal terminal RE2, and re3 represents the third reset control signal of the third reset control signal terminal RE3. The time period tyx2-1 of the second effective level YX2-1 (e.g., low level) and the time period tyx2-2 of the second effective level YX2-2 (e.g., low level) of the scanning signal ga both occur before the time period tcf of the compensating control signal cf (e.g., high level).

Of course, in one data refresh phase, the effective levels of the first scanning signal terminal may also include three or more second effective levels. Further, the time period of three or more second effective levels occurs before the time period of the effective level of the compensation control signal. In practice, the number of second effective levels that occur before the time period of the effective level of the compensation control signal can be determined according to the needs of the actual application environment, which is not limited here.

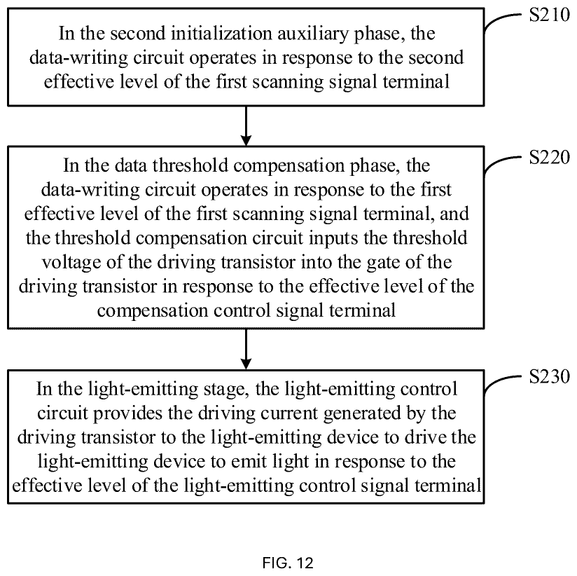

The embodiments of the disclosure further provide a driving method for a pixel circuit, including a data refresh phase. Exemplarily, as shown in FIG. 12, the data refresh phase includes the following steps:
S210, in the second initialization auxiliary phase, the data-writing circuit operates in response to the second effective level of the first scanning signal terminal;
S220, in the data threshold compensation phase, the data-writing circuit operates in response to the first effective level of the first scanning signal terminal, and the threshold compensation circuit inputs the threshold voltage of the driving transistor into the gate of the driving transistor in response to the effective level of the compensation control signal terminal;
S230, in the light-emitting stage, the light-emitting control circuit provides the driving current generated by the driving transistor to the light-emitting device to drive the light-emitting device to emit light in response to the effective level of the light-emitting control signal terminal.

In the embodiments of the present disclosure, before the data threshold compensation phase, the method further includes: a first initialization phase. In the first initialization phase, the first initialization circuit provides the signal of the first initialization signal terminal to the first electrode of the driving transistor in response to the fourth effective level of the first reset control signal terminal.

In the embodiments of the present disclosure, between the first initialization phase and the data threshold compensation phase, the method further includes: a second initialization phase. In the second initialization phase, the second initialization circuit is configured to provide the signal from the second initialization signal terminal to the second electrode of the driving transistor in response to the fifth effective level of the second reset control signal terminal.

Optionally, in the first initialization phase, the method further includes: the third initialization circuit provides the signal from the third initialization signal terminal to the light-emitting device in response to the effective level of the third reset control signal terminal.

Optionally, in the second initialization phase, the method further includes: the third initialization circuit provides the signal from the third initialization signal terminal to the light-emitting device in response to the effective level of the third reset control signal terminal.

In the embodiments of the present disclosure, between the data threshold compensation phase and the light-emitting phase, the method further includes: a third initialization auxiliary phase. In the third initialization auxiliary phase, the first initialization circuit provides the signal from the first initialization signal terminal to the first electrode of the driving transistor in response to the third effective level of the first reset control signal terminal.

Optionally, in the third initialization auxiliary phase, the method further includes: the third initialization circuit provides the signal from the third initialization signal terminal to the light-emitting device in response to the effective level of the third reset control signal terminal.

The operation of the pixel circuit provided in the embodiments of the present disclosure is described below by taking the pixel circuit shown in FIG. 2 as an example, combined with the signal sequence diagram shown in FIG. 10. The data refresh phase SX can include: the second initialization auxiliary phase T7, the first initialization phase T1, the second initialization phase T2, the data threshold compensation phase T3, the third initialization auxiliary phase T5, and the light-emitting phase T6. The first initialization phase T1, the second initialization phase T2, the data threshold compensation phase T3, the third initialization auxiliary phase T5 and the light-emitting phase T6 can refer to the described process in the above embodiments, and will not be repeated here.

In the second initialization auxiliary phase T7, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda5 of the data signal terminal DA to the first electrode of the driving transistor M0, so that Vs=Vda5. The data voltage Vda5 is the voltage of the grayscale to be displayed by the light-emitting device L in other rows of sub-pixels. Since the second transistor M2 is turned off, the data voltage Vda5 does not affect the voltage of the gate of the driving transistor M0, and the gate of the driving transistor M0 continues to remain at the original voltage.

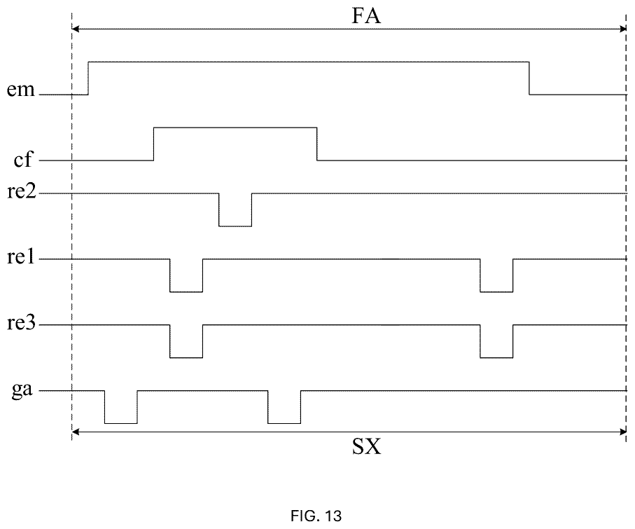

In the embodiments of the present disclosure, when the maximum refresh rate (e.g., 120 Hz) is used to drive the pixel circuit to operate, the operation of the pixel circuit in one display frame is the operation of the pixel circuit in one data refresh phase SX. For example, as shown in FIG. 13, when the pixel circuit is driven by the maximum refresh rate (e.g., 120 Hz), the operation of the pixel circuit in one display frame FA in FIG. 13 is the operation of the pixel circuit in the data refresh phase SX in FIG. 10.

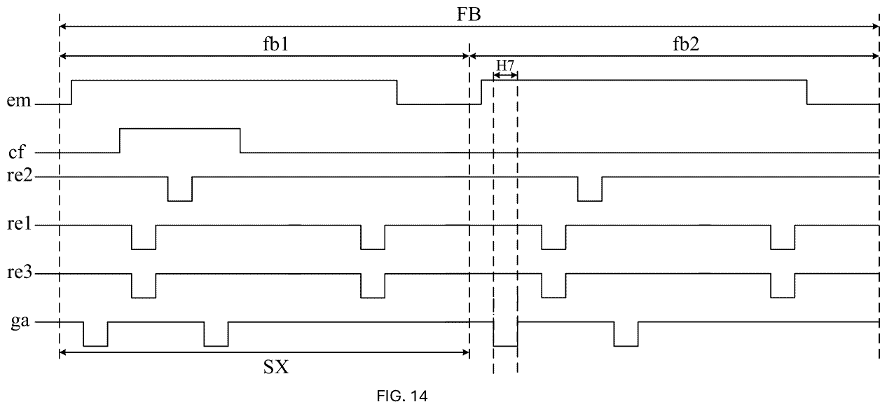

In the embodiments of the present disclosure, when other refresh rates (e.g., 1 Hz, 30 Hz, 60 Hz) less than the maximum refresh rate are used, a display frame corresponding to the pixel circuit includes a plurality of successive display sub-frames. The first display sub-frame in the plurality of display sub-frames is defined as a refresh sub-frame, the remaining display sub-frames are defined as maintaining sub-frames. The operation of the pixel circuit in a refresh sub-frame is the operation of the pixel circuit in one data refresh phase. For example, as shown in FIG. 14, the pixel circuit has a refresh sub-frame fb1 and a maintaining sub-frame fb2 in a display frame FB. The operation of the pixel circuit in the refresh sub-frame fb1 in FIG. 14 is the operation of the pixel circuit in one data refresh phase SX in FIG. 10. In the maintaining sub-frame fb2, except for the H7 phase, in which the operation is different from the above embodiments, operations in other phases are the same as the operations in the above embodiments, and will not be repeated herein.

In the H7 phase, the first transistor M1 is turned on under the control of the low level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned off under the control of the high level of the second reset control signal re2, and the seventh transistor M7 is turned off under the control of the high level of the third reset control signal re3.

The turned-on first transistor M1 provides the data voltage Vda6 of the data signal terminal DA to the first electrode of the driving transistor M0, so that Vs=Vda6. The data voltage Vda6 is the voltage of the grayscale to be displayed by the light-emitting device L in other rows of sub-pixels. Since the second transistor M2 is turned off, the data voltage Vda6 does not affect the voltage of the gate of the driving transistor M0, and the gate of the driving transistor M0 continues to remain at the original voltage.

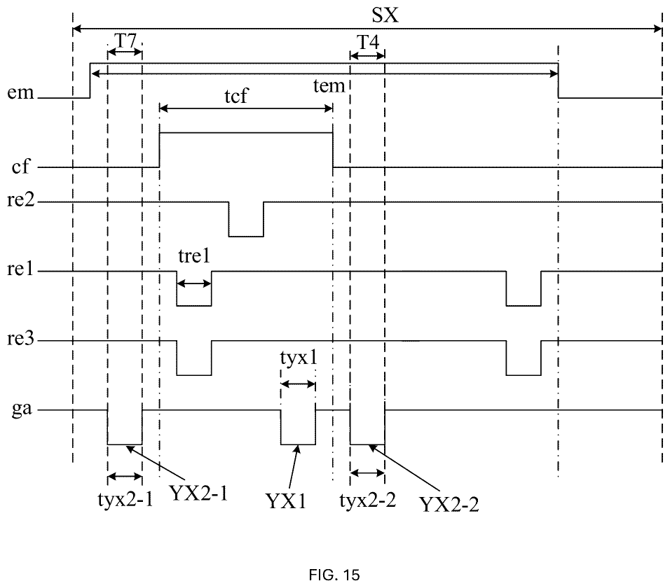

The embodiments of the present disclosure provides some signal sequence diagrams of the display panel, as shown in FIG. 15, which is deformed for the embodiments in the above embodiments. The following only explains the differences between the present embodiments and the above embodiments, and similarities between them are not repeated herein.

In some embodiments of the present disclosure, in one data refresh phase, the time period of a first part of at least one second effective level occurs before the time period of the effective level of the compensation control signal terminal, and the time period of a second part of at least one second effective level occurs after the time period of the effective level of the compensation control signal terminal.

Exemplarily, as shown in FIG. 15, SX represents a data refresh phase SX, em represents the light-emitting control signal of the light-emitting control signal terminal EM, cf represents the compensation control signal of the compensation control signal terminal CF, ga represents the scanning signal of the first scanning signal terminal GA, re1 represents the first reset control signal of the first reset control signal terminal RE1, re2 represents the second reset control signal of the second reset control signal terminal RE2, and re3 represents the third reset control signal of the third reset control signal terminal RE3. The multiple effective levels of the first scanning signal terminal GA may include two second effective levels YX2-1 and YX2-2. The time period tyx2-1 of the second effective level YX2-1 occurs before the time period tcf of the effective level of the compensation control signal terminal CF, and the time period tyx2-2 of the second effective level YX2-2 occurs after the time period tcf of the effective level of the compensation control signal terminal CF. That is, the time period tyx2-1 of the second effective level of the scanning signal ga occurs before the time period tcf of the effective level of the compensation control signal cf, and the time period tyx2-2 of the second effective level YX2-2 occurs after the time period tcf of the effective level of the compensation control signal cf.

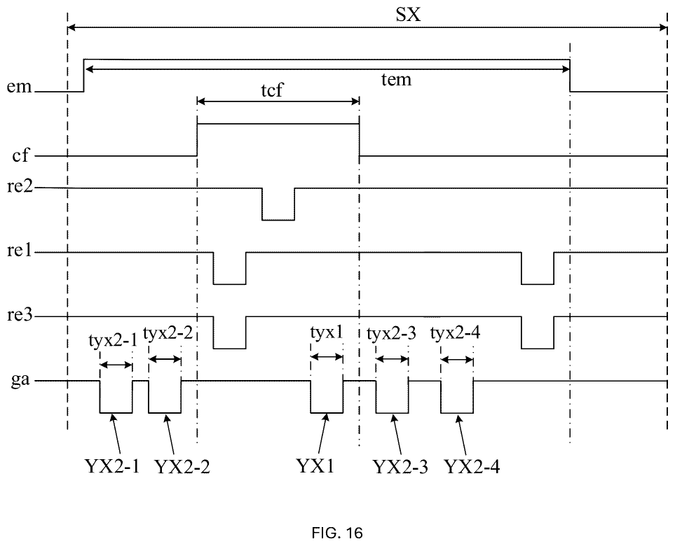

Exemplarily, as shown in FIG. 16, SX represents a data refresh phase SX, em represents the light-emitting control signal of the light-emitting control signal terminal EM, cf represents the compensation control signal of the compensation control signal terminal CF, ga represents the scanning signal of the first scanning signal terminal GA, re1 represents the first reset control signal of the first reset control signal terminal RE1, re2 represents the second reset control signal of the second reset control signal terminal RE2, and re3 represents the third reset control signal of the third reset control signal terminal RE3. A plurality of effective levels in the first scanning signal terminal GA can include four second effective levels YX2-1˜YX2-4. The time period tyx2-1 of the second effective level YX2-1 and the time period tyx2-2 of the second effective level YX2-2 both occur before the time period tcf of the effective level of the compensation control signal terminal CF. The time period tyx2-3 of the second effective level YX2-3 and the time period tyx2-4 of the second effective level YX2-4 both occur after the time period tcf of the effective level of the compensation control signal terminal CF. That is, the time period tyx2-1 of the second effective level YX2-1 and the time period tyx2-2 of the second effective level YX2-2 of the scanning signal ga both occurs before the time period tcf of the effective level of the compensation control signal cf. In addition, the time period tyx2-3 of the second effective level YX2-3 of the scanning signal ga and the time period tyx2-4 of the second effective level YX2-4 both occur after the time period tcf of the effective level of the compensation control signal cf.

Exemplarily, in one data refresh phase, the number of second effective levels that occur before the time period of the effective level of the compensation control signal terminal can be the same as the number of effective levels that occur after the time period of the effective level of the compensation control signal terminal. Exemplarily, as shown in FIG. 15, in one data refresh phase SX, the number of second effective levels that occur before the time period tcf of the effective level of the compensation control signal terminal CF and the number of effective levels that occur after the time period tcf of the effective level of the compensation control signal terminal CF are one. Alternatively, as shown in FIG. 16, in one data refresh phase SX, the number of second effective levels that occur before the time period tcf of the effective level of the compensation control signal terminal CF and the number of effective levels that occur after the time period tcf of the effective level of the compensation control signal terminal CF are two.

Exemplarily, in one data refresh phase, the number of second effective levels that occur before the time period of the effective level of the compensation control signal terminal can be greater than the number of second effective levels that occur after the time period of the effective level of the compensation control signal terminal. Exemplarily, in one data refresh phase, the number of second effective levels that occur before the time period of the effective level of the compensation control signal terminal can be two, and the number of effective levels that occur after the time period of the effective level of the compensation control signal terminal can be one. Alternatively, in one data refresh phase, the number of second effective levels that occur before the time period of the effective level of the compensation control signal terminal can be three, and the number of effective levels that occur after the time period of the effective level of the compensation control signal terminal can be one or two.

Exemplarily, in one data refresh phase, the number of second effective levels that occur before the time period of the effective level of the compensation control signal terminal can be less than the number of effective levels that occur after the time period of the effective level the compensation control signal terminal. Exemplarily, in one data refresh phase, the number of second effective levels that occur before the time period of the effective level of the compensation control signal terminal can be one, and the number of effective levels that occur after the time period of the effective level of the compensation control signal terminal can be two. Alternatively, in one data refresh phase, the number of second effective levels that occur before the time period of the effective level of the compensation control signal terminal can be one or two, and the number of effective levels that occur after the time period of the effective level of the compensation control signal terminal is three.

The operation of the pixel circuit provided in the embodiments of the present disclosure is described below by taking the pixel circuit shown in FIG. 2 as an example, combined with the signal timing sequence diagram shown in FIG. 15. The data refresh phase SX can include: the second initialization auxiliary phase T7, the first initialization phase T1, the second initialization phase T2, the data threshold compensation phase T3, the first initialization auxiliary phase T4, the third initialization auxiliary phase T5 and the light-emitting phase T6. The second initialization auxiliary phase T7, the first initialization phase T1, the second initialization phase T2, the data threshold compensation phase T3, the first initialization auxiliary phase T4, the third initialization auxiliary phase T5 and the light-emitting phase T6 can refer to the described process in the above embodiments, and will not be repeated here.

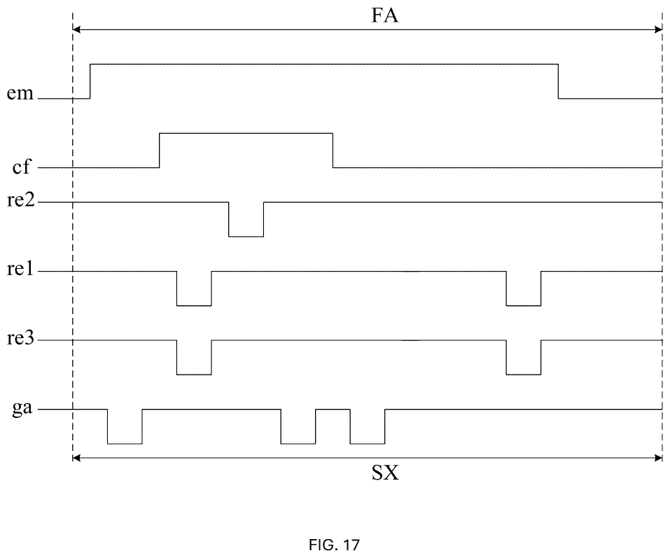

In the embodiments of the present disclosure, when the maximum refresh rate (e.g., 120 Hz) is used to drive the pixel circuit to operate, the operation of the pixel circuit in a display frame is the operation of the pixel circuit in one data refresh phase SX. For example, as shown in FIG. 17, when a pixel circuit is driven by the maximum refresh rate (e.g., 120 Hz), the operation of the pixel circuit in one display frame FA in FIG. 17 is the operation of the pixel circuit in the data refresh phase SX in FIG. 15.

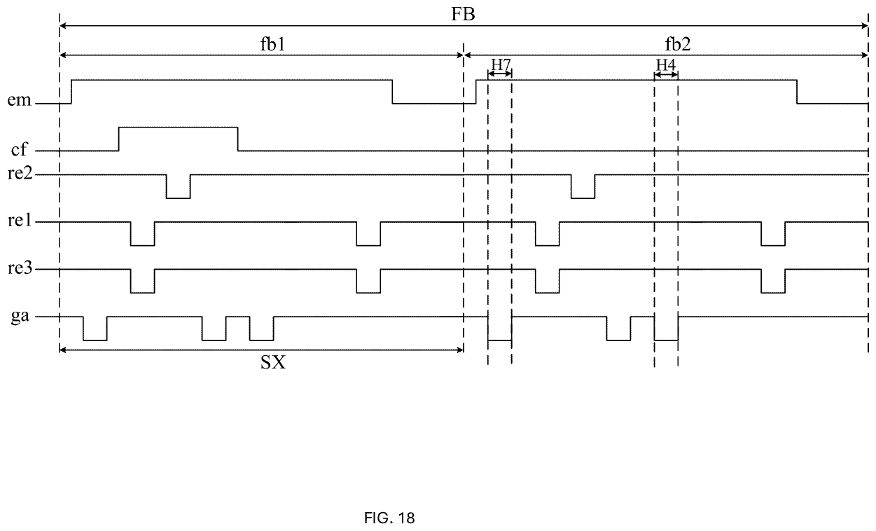

In the embodiments of the present disclosure, when adopting other refresh rates (e.g., 1 Hz, 30 Hz, 60 Hz) that are less than the maximum refresh rate, a display frame corresponding to the pixel circuit includes a plurality of successive display sub-frames. The first display sub-frame in the plurality of display sub-frames is defined as a refresh sub-frame fb1, the remaining display sub-frames are defined as maintaining sub-frames fb2. The operation of the pixel circuit in a refresh sub-frame fb1 is the operation of the pixel circuit in one data refresh phase SX. For example, as shown in FIG. 18, the pixel circuit has a refresh sub-frame fb1 and a maintaining sub-frame fb2 in a display frame FB. The operation of the pixel circuit in the refresh sub-frame fb1 in FIG. 18 is the operation of the pixel circuit in one data refresh phase SX in FIG. 15. The maintaining sub-frame may further include a H4 phase and a H7 phase. The operation in the rest of the phases is the same as the operation in the above embodiments, and will not be repeated here. In addition, the operations in the H4 phase and the H7 phase are also the same as the operations in the above embodiments, and will not be repeated here.

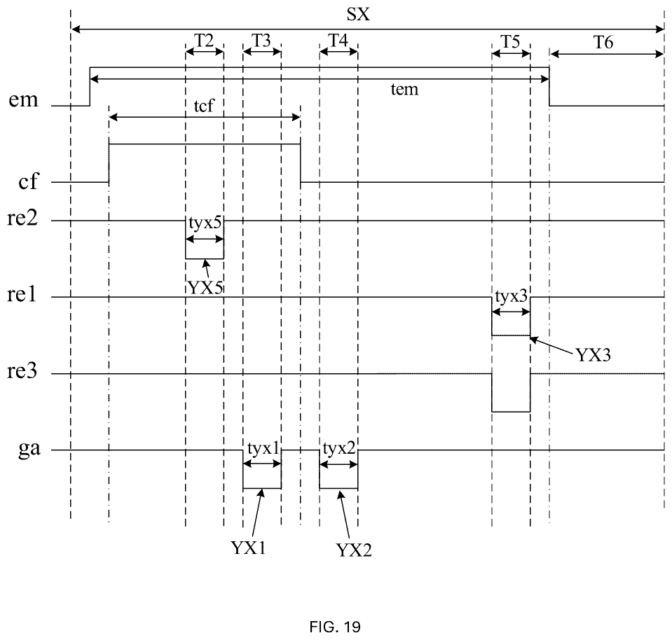

The embodiments of the present disclosure provide some other signal timing sequence diagrams of the display panel, as shown in FIG. 19, which are deformed for the embodiments in the embodiments. The following only explains the differences between the present embodiments and the above embodiments, and similarities between them are not repeated herein.

In some embodiments of the present disclosure, in one data refresh phase, a time period of at least one third effective level occurs after a time period of multiple effective levels of the first scanning signal terminal. Exemplarily, as shown in FIG. 19, in one data refresh phase SX, the effective level (e.g., low level) of the first reset control signal re1 includes a third effective level YX3. The time period tyx3 of the third effective level YX3 occurs after the time period (e.g., the time period tyx2 of the second effective level YX2) of multiple effective levels (e.g., low level) of the scanning signal ga. Alternatively, in one data refresh phase, the effective level of the first reset control signal (such as low level) can include two, three, or more third effective levels, with all the third effective levels occurring after the time period of all the effective levels of the scanning signal.

The operation of the pixel circuit provided in the embodiments of the present disclosure is described below by taking the pixel circuit shown in FIG. 2 as an example, combined with the signal timing sequence diagram shown in FIG. 19. The data refresh phase SX can include: the second initialization phase T2, the data threshold compensation phase T3, the first initialization auxiliary phase T4, the third initialization auxiliary phase T5, and the light-emitting phase T6. The operations of the second initialization phase T2, the data threshold compensation phase T3, the first initialization auxiliary phase T4, the third initialization auxiliary phase T5 and the light-emitting phase T6 are all the same as the operations of the second initialization phase T2, the data threshold compensation phase T3, the first initialization auxiliary phase T4, the third initialization auxiliary phase T5 and the light-emitting phase T6 in the above embodiments, and will not be repeated here.

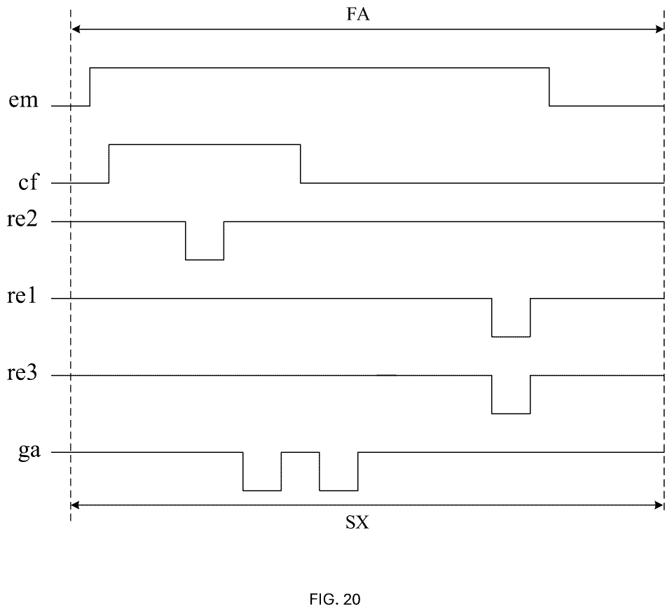

In the embodiments of the present disclosure, when the maximum refresh rate (e.g., 120 Hz) is used to drive the pixel circuit to operate, the operation of the pixel circuit in a display frame is the operation of the pixel circuit in one data refresh phase. For example, as shown in FIG. 20, when a pixel circuit is driven by the maximum refresh rate (e.g., 120 Hz), the operation of the pixel circuit in one display frame FA in FIG. 20 is the operation of the pixel circuit in one data refresh phase SX in FIG. 19.

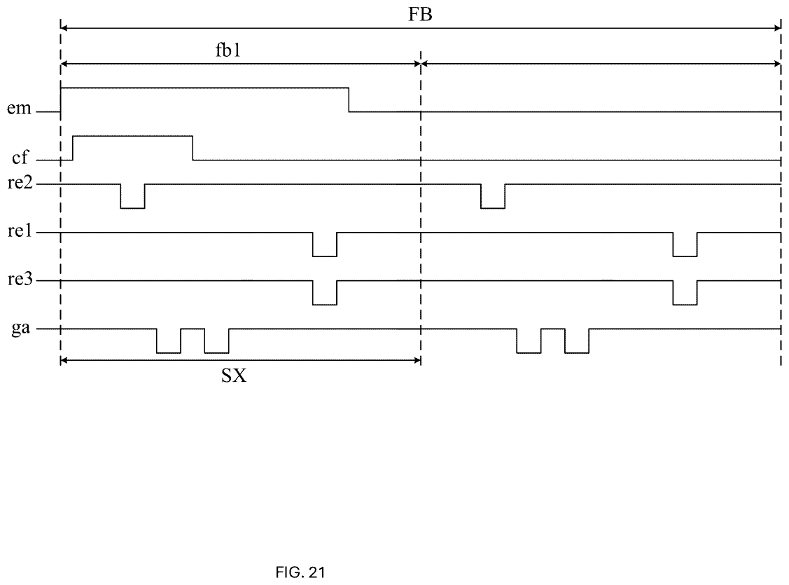

In the embodiments of the present disclosure, when other refresh rates (e.g., 1 Hz, 30 Hz, 60 Hz) less than the maximum refresh rate are used, a display frame corresponding to the pixel circuit includes a plurality of successive display sub-frames. The first display sub-frame in the plurality of display sub-frames is defined as a refresh sub-frame, the remaining display sub-frames are defined as maintaining sub-frames. The operation of the pixel circuit in the refresh sub-frame is the operation of the pixel circuit in one data refresh phase. For example, as shown in FIG. 21, the pixel circuit has a refresh sub-frame fb1 and a maintaining sub-frame fb2 in a display frame FB. The operation of the pixel circuit in the refresh sub-frame fb1 in FIG. 21 is the operation of the pixel circuit in one data refresh phase SX in FIG. 19. The operation in the maintaining sub-frame fb2 is the same as the operation in the above embodiments, and will not be repeated here.

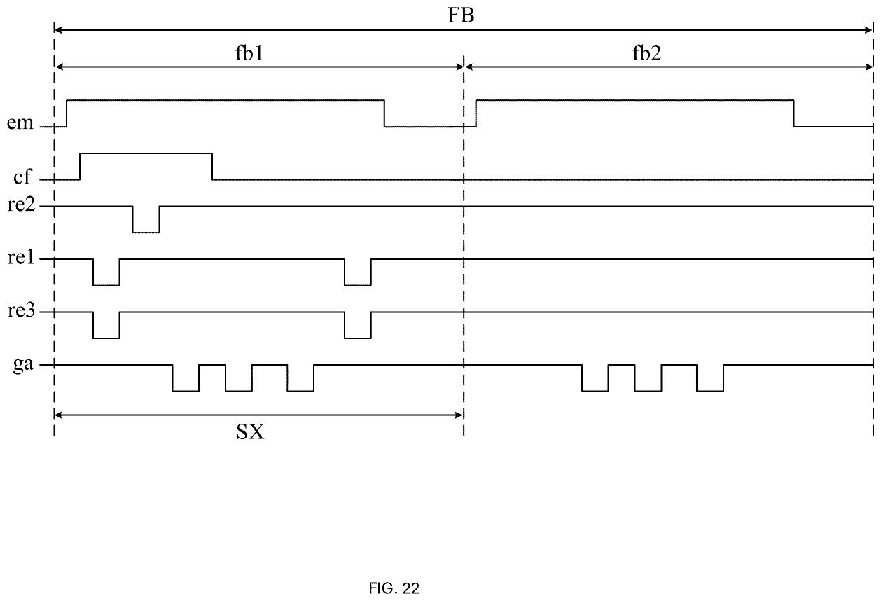

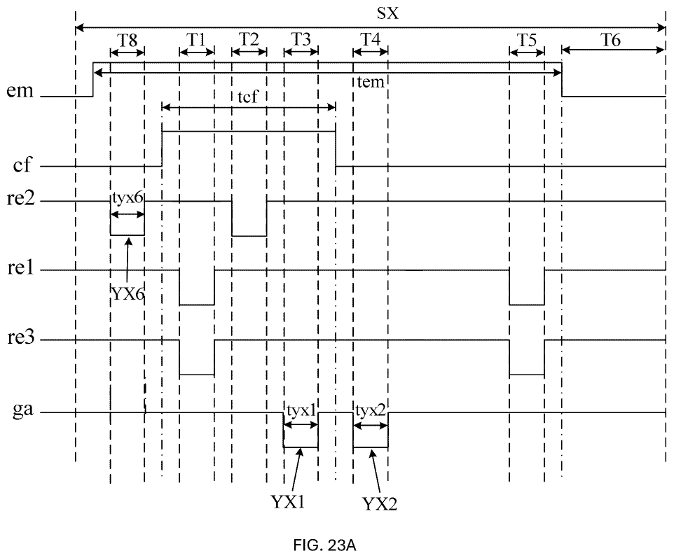

The embodiments of the present disclosure provide some other signal timing sequence diagrams of the display panel, as shown in FIG. 22, which are deformed for the embodiments in the above embodiments. The following only explains the differences between the present embodiments and the above embodiments, and similarities between them are not repeated herein.

In some other embodiments of the present disclosure, the first reset control signal terminal may also be an invalid level in the maintaining sub-frame. For example, as shown in FIG. 22, taking the effective level as low level and the invalid level as high level, the first reset control signal re1 is high level in the maintaining sub-frame fb2.

In some other embodiments of the present disclosure, the second reset control signal terminal may also be an invalid level in the maintaining sub-frame. For example, as shown in FIG. 22, the second reset control signal re2 is high level in the maintaining sub-frame fb2, taking the effective level as low level and the invalid level as high level.

In some other embodiments of the present disclosure, the third reset control signal terminal may also be an invalid level in the maintaining sub-frame. For example, as shown in FIG. 22, the third reset control signal re3 is high level in the maintaining sub-frame fb2, taking the effective level as low level and the invalid level as high level.

For example, as shown in FIG. 22, when the pixel circuit is driven with a low refresh rate, for example, with a 60 Hz refresh rate, the operation of the pixel circuit in the refresh sub-frame fb1 is the same as the operation of the pixel circuit in the data refresh phase SX. In the maintaining sub-frame fb2, firstly, the turned-on first transistor M1 provides the data voltage Vda7 of the data signal terminal DA to the first electrode of the driving transistor M0, so that Vs=Vda7. The data voltage Vda7 is the voltage of grayscale to be displayed by the light-emitting device L in other rows of sub-pixels. Since the second transistor M2 is turned off, the data voltage Vda7 does not affect the voltage of the gate of the driving transistor M0, and the voltage of the gate of the driving transistor M0 continues to remain at the original voltage.

After that, the turned-on first transistor M1 provides the data voltage Vda8 of the data signal terminal DA to the first electrode of the driving transistor M0, so that Vs=Vda8. The data voltage Vda8 is the voltage of grayscale to be displayed by the light-emitting device L in other rows of sub-pixels. Since the second transistor M2 is turned off, the data voltage Vda8 does not affect the voltage of the gate of the driving transistor M0, and the gate of the driving transistor M0 continues to remain at the original voltage.

After that, the turned-on first transistor M1 provides the data voltage Vda9 of the data signal terminal DA to the first electrode of the driving transistor M0, so that Vs=Vda9. The data voltage Vda9 is the voltage of grayscale to be displayed by the light-emitting device L in other rows of sub-pixels. Since the second transistor M2 is turned off, the data voltage Vda9 does not affect the voltage of the gate of the driving transistor M0, and the gate of the driving transistor M0 continues to remain at the original voltage. After that, the method enters the light-emitting phase.

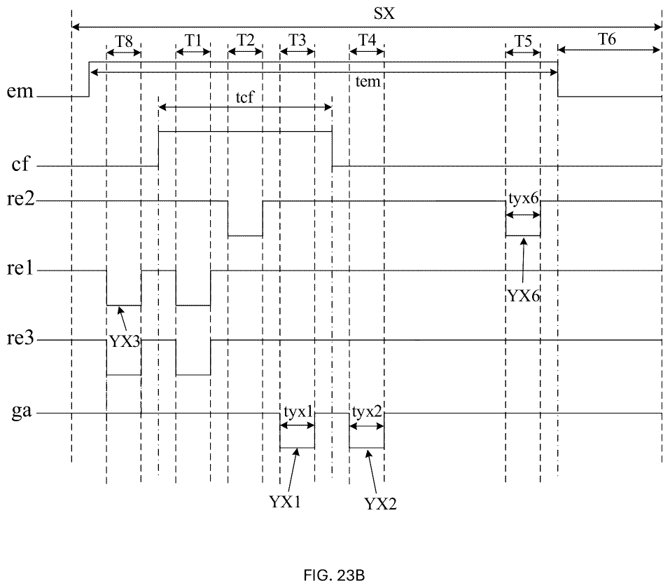

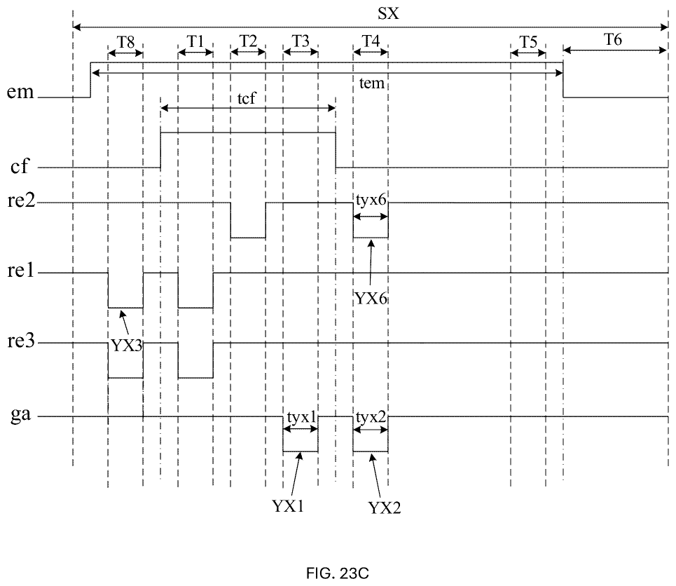

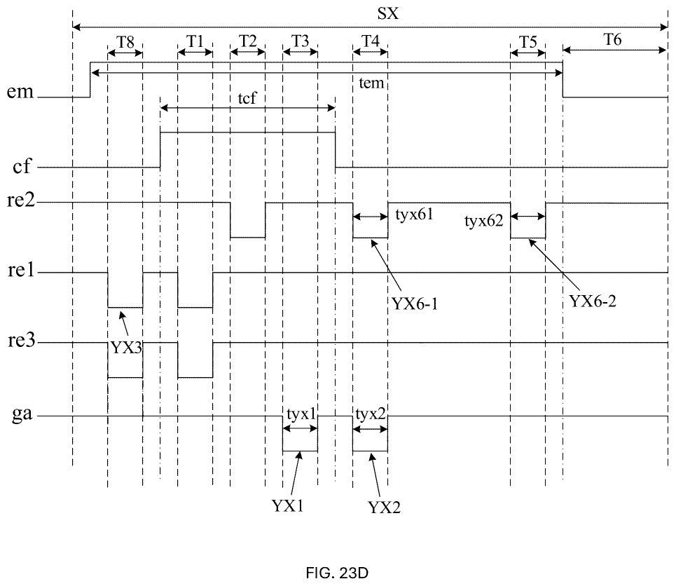

The embodiments of the present disclosure provide some other signal timing sequence diagrams of the display panel, as shown in FIG. 23A, which are deformed for the embodiments in the embodiments. The following only explains the differences between the present embodiments and the above embodiments, and similarities between them are not repeated herein.

In some embodiments of the present disclosure, the effective level of the second reset control signal terminal includes at least one sixth effective level. For example, the effective level of the second reset control signal terminal includes one, two, three, or more sixth effective levels. Further, in one data refresh phase, the time period of all the sixth effective levels occurs before the time period of the effective level of the compensation control signal terminal. For example, as shown in FIG. 23A, taking the effective level (e.g., low level) of the second reset control signal terminal RE2 including one sixth effective level YX6 as an example, in one data refresh phase SX, the time period tyx6 of the sixth effective level YX6 occurs before the time period tcf of the effective level (e.g., high level) of the compensation control signal cf.

Alternatively, in some embodiments of the present disclosure, the effective level of the second reset control signal terminal includes at least one sixth effective level. For example, the effective level of the second reset control signal terminal includes one, two, three, or more sixth effective levels. Further, in one data refresh phase, the time period of all the sixth effective levels occurs after the time period of the effective level of the compensation control signal side.

Alternatively, in some embodiments of the present disclosure, the effective level of the second reset control signal terminal includes a plurality of sixth effective levels. For example, the effective level of the second reset control signal terminal includes two, three, or more sixth effective levels. In addition, in one data refresh phase, the time period of parts of the sixth effective levels can occur before the time period of the effective level of the compensation control signal terminal, and the time period of parts of the sixth effective levels can occur after the time period of the effective level of the compensation control signal terminal, which is not limited herein.

For example, a functional circuit may include a second initialization circuit. The second scanning signal terminal may include a second reset control signal terminal. The seventh effective level of the second scanning signal terminal may include the fifth effective level returned by the second reset control signal terminal, and the eighth effective level of the second scanning signal terminal may include the sixth effective level returned by the second reset control signal terminal.

The operation of the pixel circuit provided in the embodiments of the present disclosure is described below by taking the pixel circuit shown in FIG. 2 as an example, combined with the signal timing sequence diagram shown in FIG. 23A. The data refresh phase SX can include: the fourth initialization auxiliary phase T8, the first initialization phase T1, the second initialization phase T2, the data threshold compensation phase T3, the first initialization auxiliary phase T4, the third initialization auxiliary phase T5 and the light-emitting phase T6. The first initialization phase T1, the second initialization phase T2, the data threshold compensation phase T3, the first initialization auxiliary phase T4, the third initialization auxiliary phase T5 and the light-emitting phase T6 can refer to the described process in the above embodiments, which will not be repeated here.

In the fourth initialization auxiliary phase T8, the first transistor M1 is turned off under the control of the high level of the scanning signal ga, the second transistor M2 is turned off under the control of the low level of the compensation control signal cf, the third transistor M3 and the fourth transistor M4 are turned off under the control of the high level of the light-emitting control signal em, the fifth transistor M5 is turned off under the control of the high level of the first reset control signal re1, the sixth transistor M6 is turned on under the control of the low level of the second reset control signal terminal RE2, and the seventh transistor M7 is turned off under the control of the high level of the third reset control signal re3. The turned-on sixth transistor M6 provides the second initialization signal of the second initialization signal terminal VINIT2 to the second electrode of the driving transistor M0, so that the voltage Vd of the second electrode of the driving transistor M0 is the voltage Vinit2 of the second initialization signal, that is, Vd=Vinit2, and the second electrode of the driving transistor M0 is initialized.

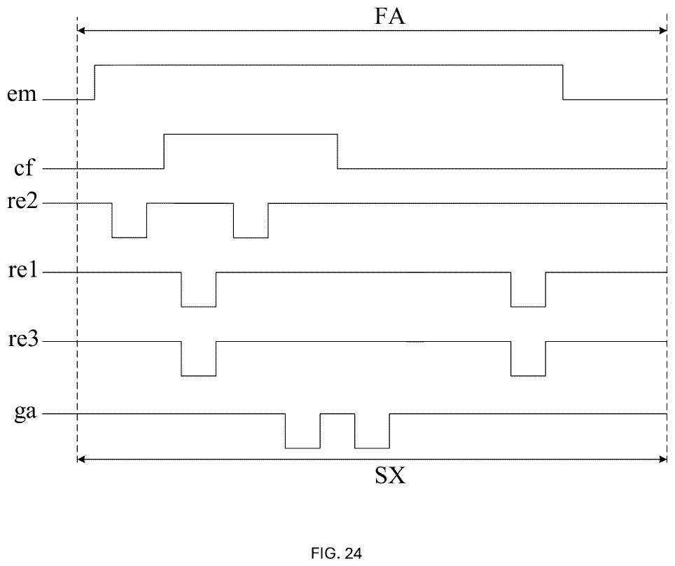

In the embodiments of the present disclosure, when the maximum refresh rate (e.g., 120 Hz) is used to drive the pixel circuit to operate, the operation of the pixel circuit in a display frame is the operation of the pixel circuit in one data refresh phase. For example, as shown in FIG. 24, when a pixel circuit is driven by the maximum refresh rate (e.g., 120 Hz), the operation of the pixel circuit in one display frame FA in FIG. 24 is the operation of the pixel circuit in the data refresh phase SX in FIG. 23A.

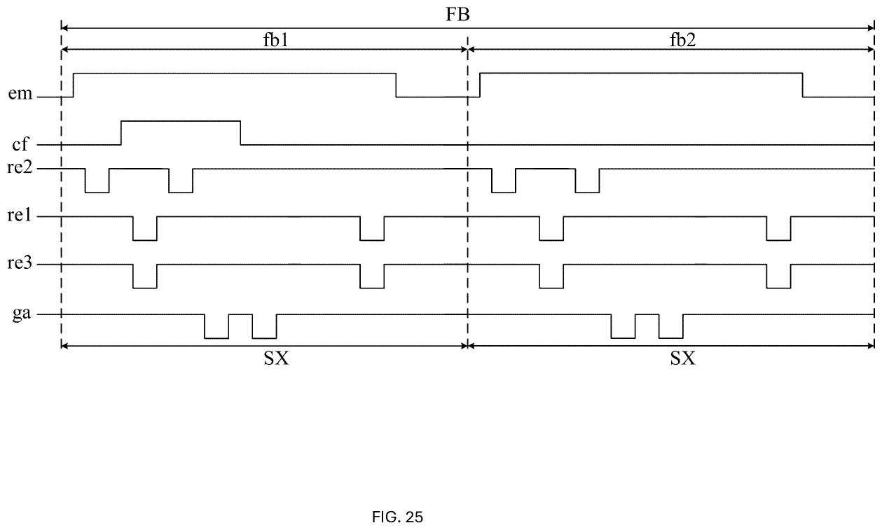

In the embodiments of the present disclosure, when other refresh rates (e.g., 1 Hz, 30 Hz, 60 Hz) less than the maximum refresh rate are used, a display frame corresponding to a pixel circuit includes a plurality of successive display sub-frames. The first display sub-frame in the plurality of display sub-frames is defined as a refresh sub-frame, the maintaining display sub-frames are defined as maintaining sub-frames. The operation of the pixel circuit in a refresh sub-frame is the operation of the pixel circuit in one data refresh phase. For example, as shown in FIG. 25, the pixel circuit has a refresh sub-frame fb1 and a maintaining sub-frame fb2 in a display frame FB. The operation of the pixel circuit in the refresh sub-frame fb1 in FIG. 25 is the operation of the pixel circuit in one data refresh phase SX in FIG. 23A. The operation in the maintaining sub-frame fb2 is the same as the operation in the above embodiments, and will not be repeated here.

The embodiments of the present disclosure provide some other signal timing sequence diagrams of the display panel, as shown in FIG. 23B to FIG. 23D, which are deformed for the embodiments in the above embodiments. The following only explains the differences between the present embodiments and the above embodiments, and similarities between them are not repeated herein.

In some embodiments of the present disclosure, in one data refresh phase, the effective level of the first reset control signal terminal includes at least one third effective level. The time period of at least one third effective level occurs before the time period of the effective level of the compensation control signal terminal. For example, as shown in FIG. 23B to FIG. 23D, taking the effective level (e.g., low level) of the first reset control signal terminal RE1 including one third effective level YX3 as an example, in one data refresh phase SX, the time period tyx3 of the third effective level YX3 occurs before the time period tcf of the effective level (e.g., high level) of the compensation control signal cf.

For example, as shown in FIG. 23B to FIG. 23D, the third effective level YX3 is set in the fourth initialization auxiliary phase T8.

For example, as shown in FIG. 7 and FIG. 23B to FIG. 23D, the third effective level YX3 included in the first reset control signal terminal RE1 is set before the time period tcf of the effective level (e.g., high level) of the compensation control signal cf, such as in the fourth initialization auxiliary phase T8. The fourth effective level YX4 is set after the time period of the first effective level YX1, such as the time period in which the first initialization auxiliary phase T4, and/or the third initialization auxiliary phase T5 is/are located. This makes the potential of source and drain electrodes of the driving transistor uniform before or after the data voltage is written. Similarly, the third reset control signal terminal RE3 can also adopt the same design as the first reset control signal terminal RE1, which will not be repeated here. In some embodiments of the present disclosure, the effective level of the second reset control signal terminal includes at least one sixth effective level. For example, the effective level of the second reset control signal terminal includes one, two, three, or more sixth effective levels. Further, in one data refresh phase, the time period of all the sixth effective levels can occur after the time period of the effective level of the compensation control signal terminal. For example, as shown in FIG. 23B and FIG. 23C, taking the effective level (e.g., low level) of the second reset control signal RE2 including one sixth effective level YX6, in one data refresh phase SX, the time period tyx6 of the sixth effective level YX6 occurs after the time period tcf of the effective level (e.g., high level) of the compensation control signal cf.

For example, as shown in FIG. 23B, the sixth effective level YX6 can be set in the third initialization auxiliary phase T5.

For example, as shown in FIG. 23C, the sixth effective level YX6 can be set in the first initialization auxiliary phase T4.

For example, as shown in FIG. 23D, taking the effective level (such as low level) of the second reset control signal terminal RE2 including two sixth effective levels YX6-1 and YX6-2 as an example, the sixth effective level YX6-1 can be set in the first initialization auxiliary phase T4, and the sixth effective level YX6-2 can be set in the third initialization auxiliary phase T5.

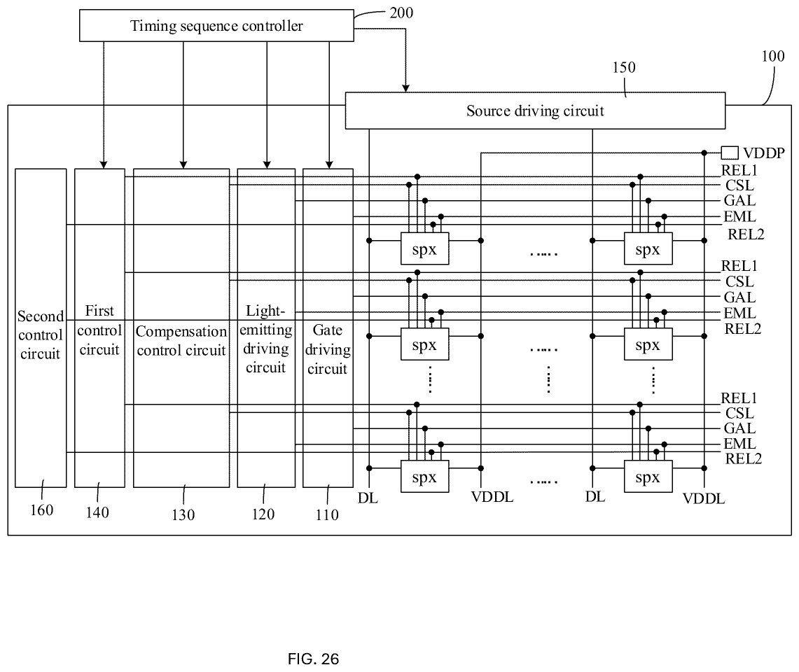

The embodiments of the disclosure further provide a display panel, as shown in FIG. 26, and the display panel 100 includes: a plurality of pixel units arranged in an array. Exemplarily, each pixel unit includes multiple sub-pixels spx. Each sub-pixel spx includes any of the above pixel circuits provided in the embodiments of the present disclosure. The principle of solving the problem of the display panel is similar to that of the aforementioned pixel circuit, so the implementation of the display panel can refer to the implementation of the aforementioned pixel circuit, and the repetition will not be repeated here.

In some embodiments of the present disclosure, as shown in FIG. 26, the display panel 100 further includes a plurality of scanning signal lines GAL. One scanning signal line GAL of the plurality of scanning signal lines GAL is coupled with the first scanning signal terminal GA of a pixel circuit in a row of sub-pixels.

In some embodiments of the present disclosure, as shown in FIG. 26, the display panel 100 further includes a gate driving circuit 110. The gate driving circuit 110 is coupled with a plurality of scanning signal lines GAL. The gate driving circuit 110 is configured to input a scanning signal to the plurality of scanning signal lines GAL.

In some embodiments of the present disclosure, as shown in FIG. 26, the display panel 100 further includes a plurality of compensation control signal lines CSL. One compensation control signal line CSL of the plurality of compensation control signal lines CSL is coupled with the compensation control signal terminal CF of the pixel circuit in a row of sub-pixels.

In some embodiments of the present disclosure, as shown in FIG. 26, the display panel 100 further includes a compensation control driving circuit 130. The compensation control driving circuit 130 is respectively coupled with a plurality of compensation control signal lines CSL. The compensation control driving circuit 130 is configured to input corresponding compensation control signals to the plurality of compensation control signal lines CSL.

In some embodiments of the present disclosure, as shown in FIG. 26, the display panel 100 further includes a plurality of light-emitting control signal lines EML. One light-emitting control signal line EML of the plurality of light-emitting control signal lines EML is coupled with the light-emitting control signal terminal EM of the pixel circuit in a row of sub-pixels.

In some embodiments of the present disclosure, as shown in FIG. 26, the display panel 100 further includes a light-emitting driving circuit 120. The light-emitting driving circuit 120 is coupled with a plurality of light-emitting control signal lines EML respectively. The light-emitting driving circuit 120 is configured to input a corresponding light-emitting control signal to the plurality of light-emitting control signal lines EML.

In some embodiments of the present disclosure, as shown in FIG. 26, the display panel 100 further includes a plurality of first reset control signal lines REL1. One first reset control signal line REL1 of the plurality of first reset control signal lines REL1 is coupled with the first reset control signal terminal RE1 of the pixel circuit in a row of sub-pixels.

In some embodiments of the present disclosure, as shown in FIG. 26, the display panel 100 further includes a first control circuit 140. The first control circuit 140 is coupled with the plurality of first reset control signal lines REL1 respectively. The first control circuit 140 is configured to input a corresponding first reset control signal to the plurality of first reset control signal lines REL1.

In some embodiments of the present disclosure, one first reset control signal line REL1 of the plurality of first reset control signal lines REL1 is coupled with the third reset control signal terminal RE3 of the pixel circuit in a row of sub-pixels.

In some embodiments of the present disclosure, as shown in FIG. 26, the display panel 100 further includes a plurality of second reset control signal lines REL2. One second reset control signal line REL2 of the plurality of second reset control signal lines REL2 is coupled with the second reset control signal terminal RE2 of the pixel circuit in a row of sub-pixels.

In some embodiments of the present disclosure, as shown in FIG. 26, the display panel 100 further includes a second control circuit 160. The second control circuit 160 is coupled with a plurality of second reset control signal lines REL2 respectively. The second control circuit 160 is configured to input a corresponding second reset control signal to the plurality of second reset control signal lines REL2.

In some embodiments of the present disclosure, as shown in FIG. 26, the display panel 100 further includes a plurality of data lines DL and a plurality of first power lines VDDL. The plurality of data lines DL and the plurality of first power lines VDDL extend along the column direction of the sub-pixels. Optionally, one data line DL of the plurality of data lines DL is coupled to the data signal terminal DA of the pixel circuit in a row of sub-pixels. One first power line VDDL of the plurality of first power lines VDDL is coupled to the first power supply terminal VDD of the pixel circuit in a row of sub-pixels.

In some embodiments of the present disclosure, as shown in FIG. 26, the display panel 100 further includes a source driving circuit 150. The source driving circuit 150 is coupled with the plurality of data lines DL respectively. Exemplarily, the source driving circuit 150 can be set to one. Alternatively, the source driving circuit can be set to two, with one source driving circuit connecting half the number of data lines DL and the other source driving circuit connecting the other half number of data lines DL. Of course, the source driving circuit can also be set up with 3, 4, or more, which can be designed and determined according to the needs of the actual application, and the disclosure is not limited to this.

In the embodiments of the disclosure, a thin film transistor (TFT) may be prepared on the array substrate of the display panel by using the gate driver on array (GOA) technology to form a gate driving circuit 110, a light-emitting driving circuit 120, a compensation control circuit 130, a first control circuit 140 and a second control circuit 160. In this way, all of the gate driving circuit 110, the light-emitting driving circuit 120, the compensation control circuit 130, the first control circuit 140 and the second control circuit 160 can be equivalent to GOA circuits. In addition, in the embodiments of the present disclosure, the operation of the pixel circuit can be controlled by sharing the signal terminals of the pixel circuit, only five groups of GOA circuits are required. This reduces the number of GOA circuits and facilitates the implementation of narrow bezels.

In some embodiments of the present disclosure, in one data refresh phase, a plurality of effective levels of the first scanning signal terminal of the pixel circuit include at least one second effective level. When the time period of at least one second effective level in at least one second effective level occurs after the time period of the effective level of the compensation control signal terminal, the time period of the second effective level corresponding to the pixel circuit in the n^{th} row of sub-pixels overlaps with the time period of the first effective level corresponding to the pixel circuit in the (n+m)^{th} row of sub-pixels. n is an integer and n>0, m is an integer and m>0.

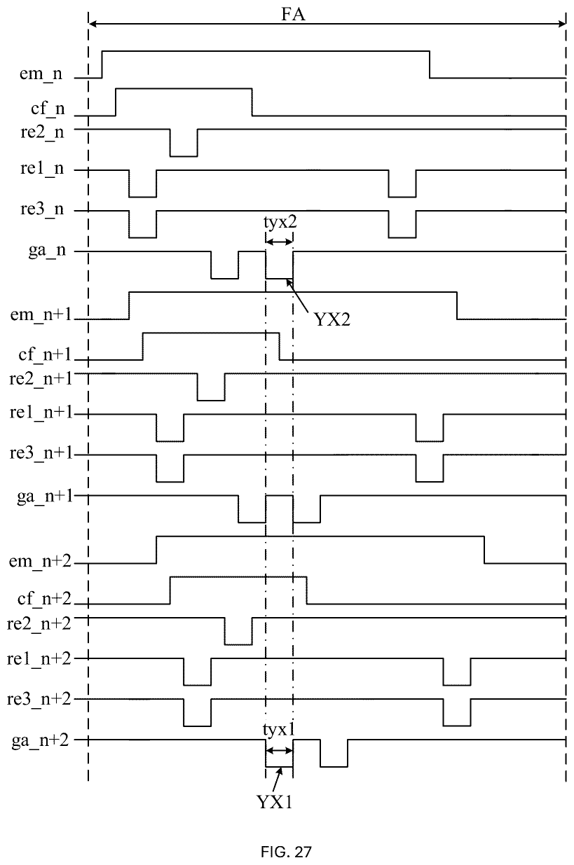

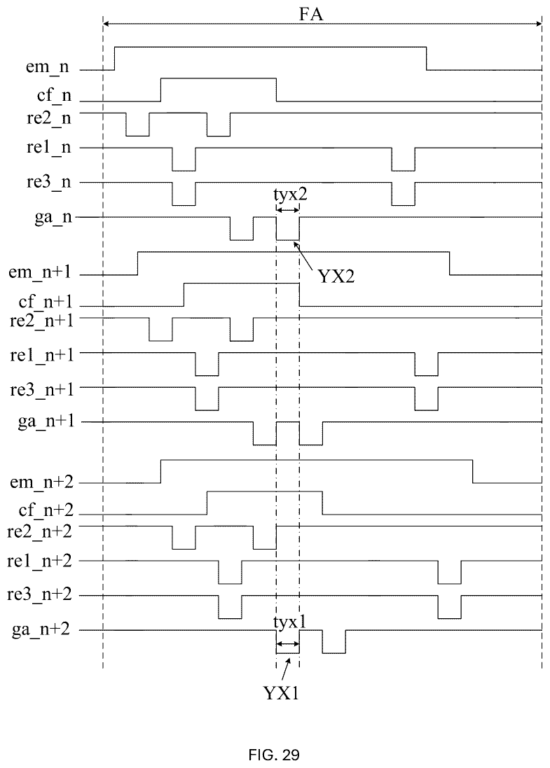

Exemplarily, taking m=2 as an example, when the maximum refresh rate (e.g., 120 Hz) is used to drive the pixel circuit to operate, the signal timing sequence diagram corresponding to the n^{th} row of sub-pixels to the (n+2)^{th} row of sub-pixel is shown in FIG. 27 and FIG. 29. In FIG. 27 and FIG. 29, em_n represents the light-emitting control signal corresponding to the pixel circuit in the n^{th} row of sub-pixels, cf_n represents the compensation control signal corresponding to the pixel circuit in the n^{th} row of sub-pixels, re1_n represents the first reset control signal corresponding to the pixel circuit in the n^{th} row of sub-pixels, re2_n represents the second reset control signal corresponding to the pixel circuit in the n^{th} row of sub-pixels, and re3_n represents the third reset control signal corresponding to the pixel circuit in the n^{th} row of sub-pixels, ga_n represents the scanning signal corresponding to the pixel circuit in the n^{th} row of sub-pixels, em_n+1 represents the light-emitting control signal corresponding to the pixel circuit in the (n+1)^{th} row of sub-pixel, cf_n+1 represents the compensation control signal corresponding to the pixel circuit in the (n+1)^{th} row of sub-pixels, re1_n+1 represents the first reset control signal corresponding to the pixel circuit in the (n+1)^{th} row of the sub-pixels, re2_n+1 represents the second reset control signal corresponding to the pixel circuit in the (n+1)^{th} row of sub-pixels, and re3_n+1 represents the third reset control signal corresponding to the pixel circuit in the (n+1)^{th} row of sub-pixels, ga_n+1 represents the scanning signal corresponding to the pixel circuit in the (n+1)^{th} row of sub-pixels. em_n+2 represents the light-emitting control signal corresponding to the pixel circuit in the (n+2)^{th} row of sub-pixels, cf_n+2 represents the compensation control signal corresponding to the pixel circuit in the (n+2)^{th} row of sub-pixels, re1_n+2 represents the first reset control signal corresponding to the pixel circuit in the (n+2)^{th} row of sub-pixels, re2_n+2 represents the second reset control signal corresponding to the pixel circuit in the (n+2)^{th} row of sub-pixels, and re3_n+2 represents the third reset control signal corresponding to the pixel circuit in the (n+2)^{th} row of sub-pixels, ga_n+2 represents the scanning signal corresponding to the pixel circuit in the (n+2)^{th} row of sub-pixels. As shown in FIG. 27 and FIG. 29, the time period tyx2 of the second effective level YX2 corresponding to the pixel circuit in the n^{th} row of sub-pixels overlaps with the time period tyx1 of the first effective level YX1 corresponding to the pixel circuit in the (n+2)^{th} row of sub-pixels. In this way, for the sub-pixels in the same column, the first electrode of the driving transistor M0 of the pixel circuit in the n^{th} row of sub-pixels can be biased by the data voltage corresponding to the pixel circuit in the (n+2)^{th} row of sub-pixels, so that the bias state of the first electrode of the driving transistor M0 changes with the change of the data voltage, and the characteristic stability of the driving transistor M0 is improved.

Exemplarily, m=1, 3, 4, 5, or more, without qualifying here.

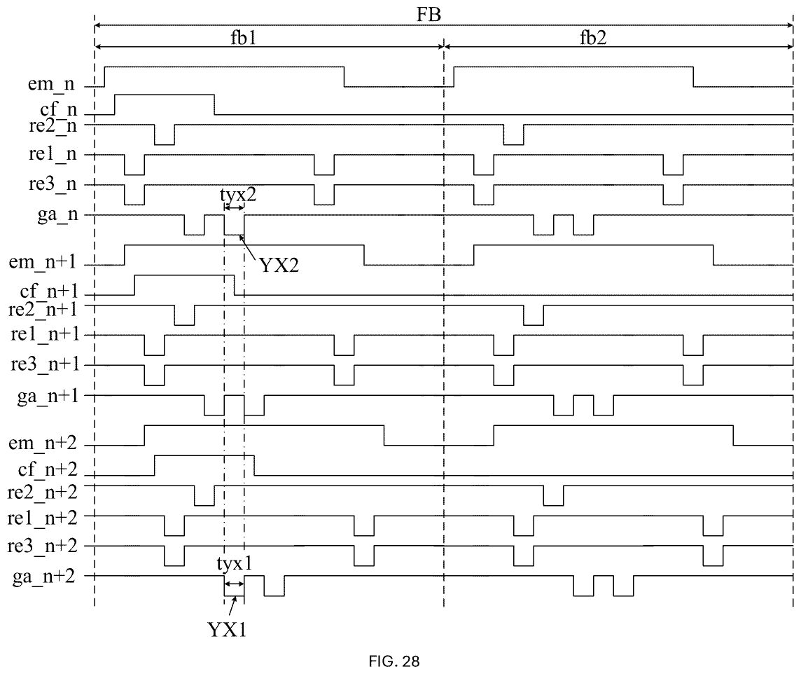

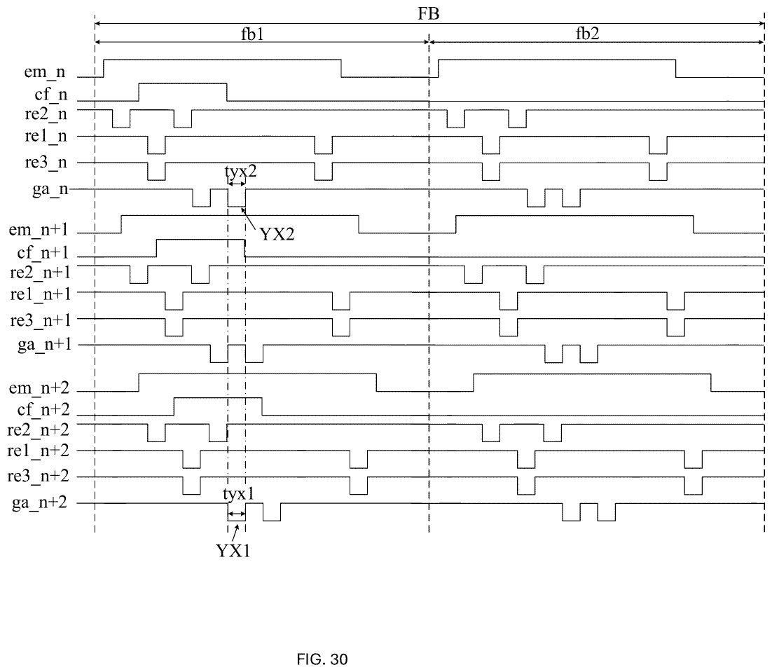

Exemplarily, taking m=2 as an example, when the pixel circuit is driven by other refresh rates (e.g., 1 Hz, 30 Hz, 60 Hz) smaller than the maximum refresh rate, the signal timing sequence diagram corresponding to the n^{th} row of sub-pixels to the (n+2)^{th} row of sub-pixels is shown in FIG. 28 and FIG. 30. In FIG. 28 and FIG. 30, em_n represents the light-emitting control signal corresponding to the pixel circuit in the n^{th} row of sub-pixels, cf_n represents the compensation control signal corresponding to the pixel circuit in the n^{th} row of sub-pixels, re1_n represents the first reset control signal corresponding to the pixel circuit in the n^{th} row of sub-pixels, re2_n represents the second reset control signal corresponding to the pixel circuit in the n^{th} row of sub-pixels, re3_n represents the third reset control signal corresponding to the pixel circuit in the n^{th} row of sub-pixels, ga_n represents the scanning signal corresponding to the pixel circuit in the n^{th} row of sub-pixels. em_n+1 represents the light-emitting control signal corresponding to the pixel circuit in the (n+1)^{th} row of sub-pixels, cf_n+1 represents the compensation control signal corresponding to the pixel circuit in the (n+1)^{th} row of sub-pixels, re1_n+1 represents the first reset control signal corresponding to the pixel circuit in the (n+1)^{th} row of sub-pixels, re2_n+1 represents the second reset control signal corresponding to the pixel circuit in the (n+1)^{th} row of the sub-pixels, and re3_n+1 represents the third reset control signal corresponding to the pixel circuit in the (n+1)^{th} row of the sub-pixels, ga_n+1 represents the scanning signal corresponding to the pixel circuit in the (n+1)^{th} row of sub-pixels. em_n+2 represents the light-emitting control signal corresponding to the pixel circuit in the (n+2)^{th} row of sub-pixels, cf_n+2 represents the compensation control signal corresponding to the pixel circuit in the (n+2)^{th} row of sub-pixels, re1_n+2 represents the first reset control signal corresponding to the pixel circuit in the (n+2)^{th} row of sub-pixels, re2_n+2 represents the second reset control signal corresponding to the pixel circuit in the (n+2)^{th} row of sub-pixels, and re3_n+2 represents the third reset control signal corresponding to the pixel circuit in the (n+2)^{th} row of sub-pixels, ga_n+2 represents the scanning signal corresponding to the pixel circuit in the (n+2)^{th} row of sub-pixels. As shown in FIG. 28 and FIG. 30, the time period tyx2 of the second effective level YX2 corresponding to the pixel circuit in the n^{th} row of sub-pixels overlaps with the time period tyx1 of the first effective level YX1 corresponding to the pixel circuit in the (n+2)^{th} row of sub-pixels. In this way, for the sub-pixels in the same column, the first electrode of the driving transistor M0 of the pixel circuit in the n^{th} row of sub-pixels can be biased by the data voltage corresponding to the pixel circuit in the (n+2)^{th} row of sub-pixels, so that the bias state of the first electrode of the driving transistor M0 changes with the change of the data voltage, and the characteristic stability of the driving transistor M0 is improved.

Exemplarily, m=1, 3, 4, 5, or more, without qualifying here.

In some embodiments of the present disclosure, in one data refresh phase, a plurality of effective levels in the first scanning signal terminal of the pixel circuit include at least one second effective level. In one data refresh phase, when the time period of at least one second effective level in at least one second effective level occurs before the time period of the effective level of the compensation control signal terminal, the time period of the second effective level corresponding to the pixel circuit in the q^{th} row of sub-pixels overlaps with the time period of the first effective level corresponding to the pixel circuit in the (q−k)^{th} row of sub-pixels, q is an integer and q>0, k is an integer and k>0.

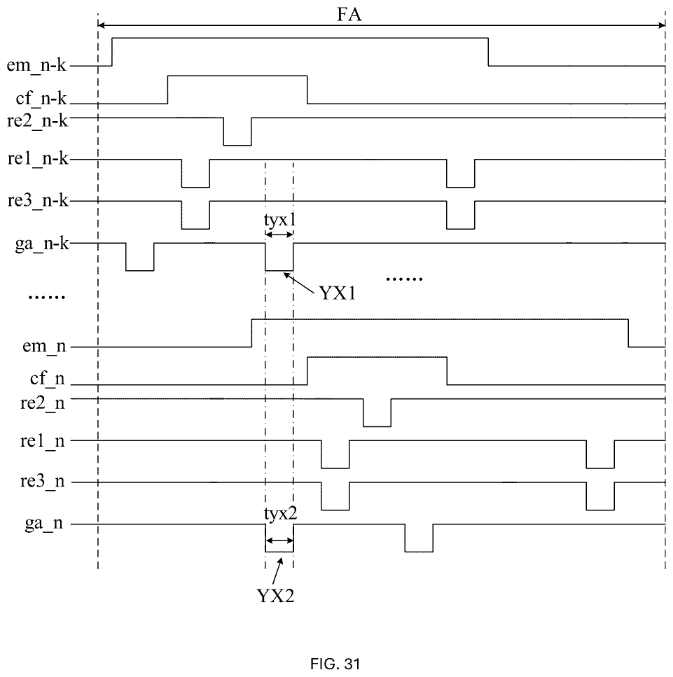

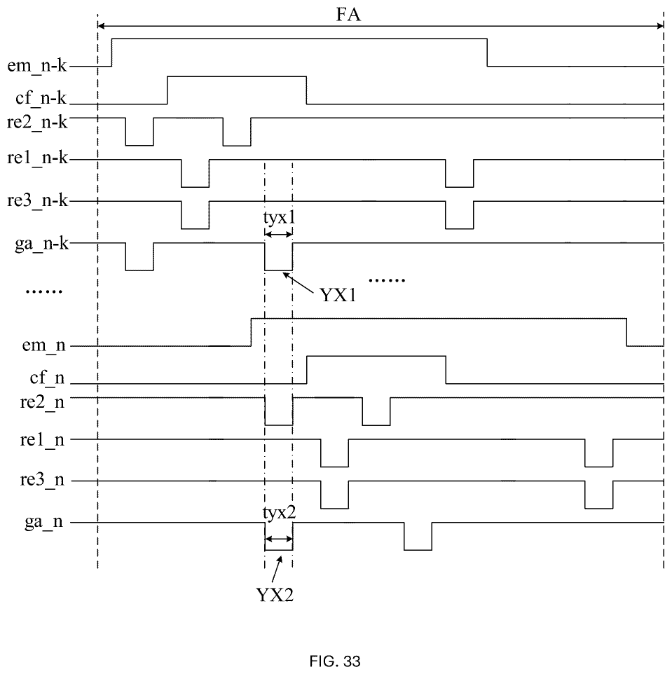

Exemplarily, when the maximum refresh rate (e.g., 120 Hz) is used to drive a pixel circuit to operate, the signal timing sequence diagram corresponding to the n^{th} row of sub-pixels to the (n+2)^{th} row of sub-pixels is shown in FIG. 31 and FIG. 33. In FIG. 31 and FIG. 33, em_n represents the light-emitting control signal corresponding to the pixel circuit in the n^{th} row of sub-pixels, cf_n represents the compensation control signal corresponding to the pixel circuit in the n^{th} row of sub-pixels, re1_n represents the first reset control signal corresponding to the pixel circuit in the n^{th} row of sub-pixels, re2_n represents the second reset control signal corresponding to the pixel circuit in the n^{th} row of sub-pixels, re3_n represents the third reset control signal corresponding to the pixel circuit in the n^{th} row of sub-pixels, ga_n represents the scanning signal corresponding to the pixel circuit in the n^{th} row of sub-pixels. em_n-k represents the light-emitting control signal corresponding to the pixel circuit in the (n−k)^{th} row of sub-pixels, cf_n-k represents the compensation control signal corresponding to the pixel circuit in the (n−k)^{th} row of sub-pixels, re1_n−k represents the first reset control signal corresponding to the pixel circuit in the (n−k)^{th} row of sub-pixels, re2_n−k represents the second reset control signal corresponding to the pixel circuit in the (n−k)^{th} row of sub-pixels, re3_n−k represents the third reset control signal corresponding to the pixel circuit in the (n−k)^{th} row of sub-pixels, ga_n-k represents the scanning signal corresponding to the pixel circuit in the (n−k)^{th} row of sub-pixels. As shown in FIG. 31 and FIG. 33, the time period tyx2 of the second effective level YX2 corresponding to the pixel circuit in the n^{th} row of sub-pixels overlaps with the time period tyx1 of the first effective level YX1 corresponding to the pixel circuit in the (n−k)^{th} row of sub-pixels. In this way, for the sub-pixels in the same column, the first electrode of the driving transistor M0 of the pixel circuit in the n^{th} row of sub-pixels can be biased by the data voltage corresponding to the pixel circuit in the (n−k)^{th} row of sub-pixels, so that the bias state of the first electrode of the driving transistor M0 changes with the change of the data voltage, and the characteristic stability of the driving transistor M0 is improved.

Exemplarily, k=1, 2, 3, 4, 5, or more, without qualification.

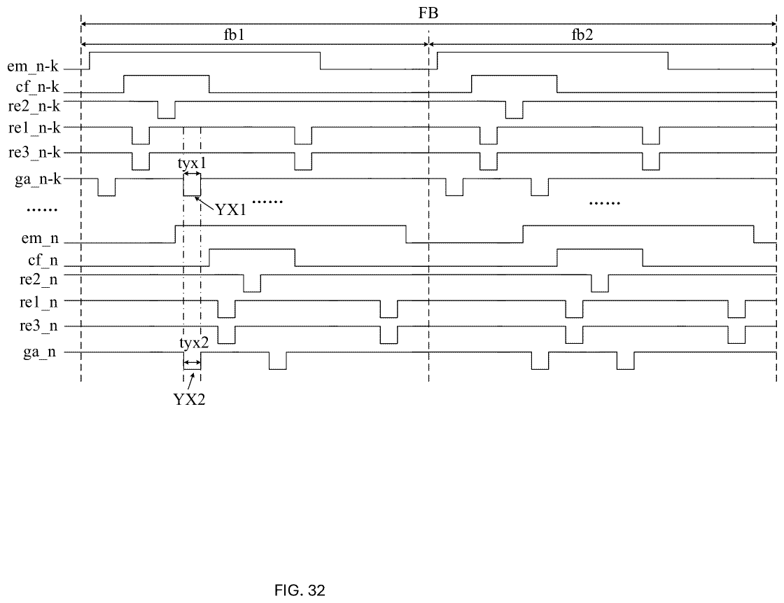

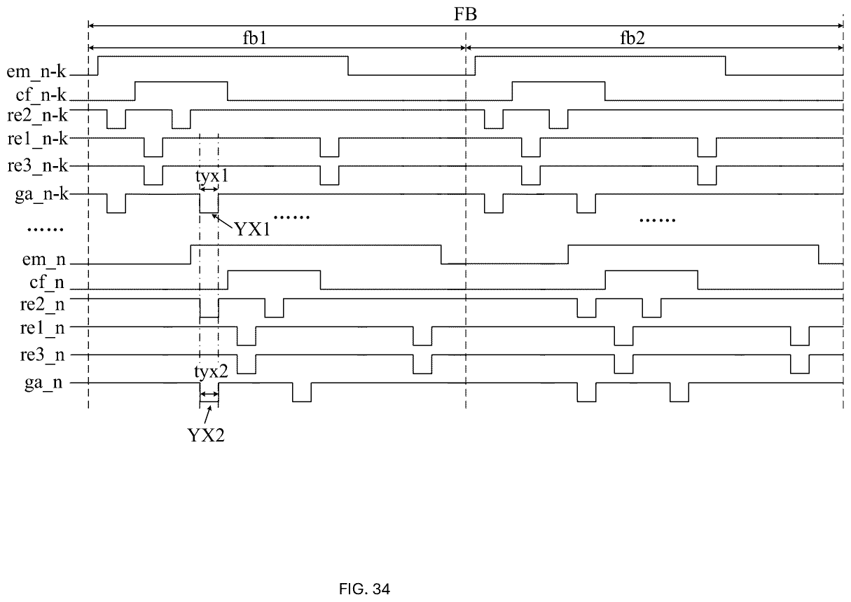

Exemplarily, when the pixel circuit is driven by other refresh rates (e.g., 1 Hz, 30 Hz, 60 Hz) smaller than the maximum refresh rate, the signal timing sequence diagram corresponding to the n^{th} row of sub-pixels to the (n+2)^{th} row of sub-pixels is shown in FIG. 32 and FIG. 34. In FIG. 32 and FIG. 34, em_n represents the light-emitting control signal corresponding to the pixel circuit in the n^{th} row of sub-pixels, cf_n represents the compensation control signal corresponding to the pixel circuit in the n^{th} row of sub-pixels, re1_n represents the first reset control signal corresponding to the pixel circuit in the n^{th} row of sub-pixels, re2_n represents the second reset control signal corresponding to the pixel circuit in the n^{th} row of sub-pixels, and re3_n represents the third reset control signal corresponding to the pixel circuit in the n^{th} row of sub-pixels, ga_n represents the scanning signal corresponding to the pixel circuit in the n^{th} row of sub-pixels. em_n-k represents the light-emitting control signal corresponding to the pixel circuit in the (n−k)^{th} row of sub-pixels, cf_n-k represents the compensation control signal corresponding to the pixel circuit in the (n−k)^{th} row of sub-pixels, re1_n−k represents the first reset control signal corresponding to the pixel circuit in the (n−k)^{th} row of sub-pixels, re2_n−k represents the second reset control signal corresponding to the pixel circuit in the (n−k)^{th} row of sub-pixels, re3_n−k represents the third reset control signal corresponding to the pixel circuit in the (n−k)^{th} row of sub-pixels, ga_n-k represents the scanning signal corresponding to the pixel circuit in the (n−k)^{th} row of sub-pixels. As shown in FIG. 32 and FIG. 34, the time period tyx2 of the second effective level YX2 corresponding to the pixel circuit in the n^{th} row of sub-pixels overlaps with the time period tyx1 of the first effective level YX1 corresponding to the pixel circuit in the (n−k)^{th} row of sub-pixels. In this way, for the sub-pixels in the same column, the first electrode of the driving transistor M0 of the pixel circuit in the n^{th} row of sub-pixels can be biased by the data voltage corresponding to the pixel circuit in the (n−k)^{th} row of sub-pixels, so that the bias state of the first electrode of the driving transistor M0 changes with the change of the data voltage, and the characteristic stability of the driving transistor M0 is improved.

Exemplarily, k=1, 2, 3, 4, 5, or more, without limitations here.

In some embodiments of the present disclosure, the time period of the effective level of the compensation control signal terminal of the pixel circuit in the s^{th} row of sub-pixels includes the time period of the first effective level corresponding to the pixel circuit in the (s−a)^{th} row of sub-pixels, where a is an integer and a>0. Exemplarily, a=1, 2, 3, 4, 5, or more, without limitations. For example, as shown in FIG. 27 and FIG. 28, the time period tcf of the effective level of the compensation control signal cf of the pixel circuit in the (n+2)^{th} row of sub-pixels includes the time period tyx1 of the first effective level YX1 corresponding to the pixel circuit in the (n+2)^{th} to n^{th} rows of sub-pixels, where a is an integer and a>0.

In some embodiments of the present disclosure, the time period tcf of the effective level of the compensation control signal terminal CF of the pixel circuit in the s^{th} row of sub-pixels includes the time period tyx1 of the first effective level YX1 corresponding to the pixel circuit in the s^{th} to (s+b)^{th} rows of sub-pixels, where b is an integer and b is >0. Exemplarily, b=1, 2, 3, 4, 5, or more, without qualification. For example, as shown in FIG. 29 and FIG. 30, the time period tcf of the effective level of the compensation control signal cf of the pixel circuit in the n^{th} row of sub-pixels includes the time period tyx1 of the first effective level YX1 corresponding to the pixel circuit in n^{th} to (n+1)^{th} rows of sub-pixels.

The embodiments of the disclosure further provide a display apparatus, as shown in FIG. 26, and the display apparatus may include a display panel 100 and a timing sequence controller 200. Exemplarily, the timing sequence controller 200 can receive display data of a to-be-displayed image of a display frame, and input corresponding control signals to the gate driving circuit 110, the light-emitting driving circuit 120, the compensation control circuit 130, the first control circuit 140 and the second control circuit 160 respectively, so that the gate driving circuit 110 outputs the corresponding scanning signal to the scanning signal line GAL, the light-emitting driving circuit 120 outputs the corresponding light-emitting control signal to the light-emitting control signal line EML, the compensation control circuit 130 outputs the corresponding compensation control signal to the compensation control signal line CSL, the first control circuit 140 outputs the corresponding first reset control signal to the first reset control signal line REL1 and the second control circuit 160 outputs the corresponding second reset control signal to the second reset control signal line REL2. In addition, the timing sequence controller 200 can further process the received display data accordingly and send processed display data to the source driving circuit 150. The source driving circuit 150 can input the corresponding data voltage to the data line DL respectively according to the received display data, and the pixel circuit can be input with the corresponding data voltage, so as to realize the screen display function of this display frame.

In the specific implementation, in the embodiments of the present disclosure, the display apparatus may be: a mobile phone, a tablet computer, a television, a monitor, a notebook computer, a digital photo frame, a navigation device, and any other product or component with a display function. The other indispensable components of the display apparatus are those reasonably skilled in the art and should be understood, and are not described herein and should not be used as a limitation on the present disclosure.

Although preferred embodiments of the present disclosure have been described, those embodiments may make additional changes and modifications to these embodiments once they have knowledge of the basic concept of inventive step. Therefore, the attached claims are intended to be construed to include the preferred embodiments and all changes and modifications that fall within the scope of the disclosure.

Obviously, a person skilled in the art may make various changes and variants to the embodiments of the present disclosure without departing from the spirit and scope of the embodiments of the present disclosure. Thus, if these modifications and variants of the present disclosure embodiments fall within the scope of the claims of the present disclosure and their equivalents, the present disclosure is also intended to include such modifications and variants.

1. A pixel circuit, comprising:
a light-emitting device;
a driving transistor configured to generate a driving current that drives the light-emitting device to emit light according to a data voltage;
a light-emitting control circuit coupled with the driving transistor, and configured to, in response to an effective level of a light-emitting control signal terminal, provide the driving current generated by the driving transistor to the light-emitting device, and drive the light-emitting device to emit light;
a data-writing circuit coupled with a first electrode of the driving transistor, and configured to operate in a data refresh phase in response to a plurality of effective levels that occur at intervals between first scanning signal terminals; and
a threshold compensation circuit coupled with the driving transistor, configured to, in response to an effective level of a compensation control signal terminal, input a threshold voltage of the driving transistor into a gate of the driving transistor;
wherein in the data refresh phase, a time period of an invalid level of the light-emitting control signal terminal comprises a time period of the effective level of the compensation control signal terminal and a time period of an effective level of the first scanning signal terminal, the effective level of the first scanning signal terminal comprises at least one first effective level and at least one second effective level, and the time period of the effective level of the compensation control signal terminal comprises a time period of the first effective level.

2. The pixel circuit of claim 1, wherein in the data refresh phase, a time period of the at least one second effective level occurs after the time period of the effective level of the compensation control signal terminal; or
wherein in the data refresh phase, a time period of the at least one second effective level occurs before the time period of the effective level of the compensation control signal terminal.

3. (canceled)

4. The pixel circuit of claim 1, further comprising: a first initialization circuit,
wherein the first initialization circuit is coupled with the first electrode of the driving transistor;
the first initialization circuit is configured to, in response to at least one effective level of a first reset control signal terminal in the data refresh phase, provide a signal of the first initialization signal terminal to the first electrode of the driving transistor;
wherein in the data refresh phase, the time period of the invalid level of the light-emitting control signal terminal further comprises a time period of the effective level of the first reset control signal terminal, and the time period of the effective level of the first reset control signal terminal does not overlap with a time period of a plurality of effective levels of the first scanning signal terminal.

5. The pixel circuit of claim 4, wherein the effective level of the first reset control signal terminal comprises at least one third effective level;
in the data refresh phase, a time period of the at least one third effective level occurs after the time period of the plurality of effective levels of the first scanning signal terminal; and/or
wherein the effective level of the first reset control signal terminal comprises at least one fourth effective level;
in the data refresh phase, the time period of the effective level of the compensation control signal terminal comprises a time period of the fourth effective level, and the time period of the fourth effective level occurs before a time period of the first effective level of the first scanning signal terminal.

6. (canceled)

7. The pixel circuit of claim 1, further comprising: a second initialization circuit,
wherein the second initialization circuit is coupled with a second electrode of the driving transistor;
the second initialization circuit is configured to, in response to at least one effective level of a second reset control signal terminal, provide a signal of a second initialization signal terminal to the second electrode of the driving transistor;
wherein in the data refresh phase, the time period of the invalid level of the light-emitting control signal terminal comprises a time period of the effective level of the second reset control signal terminal, and the time period of the effective level of the second reset control signal terminal does not overlap with a time period of a plurality of effective levels in the first scanning signal terminal.

8. The pixel circuit of claim 7, wherein the effective level of the second reset control signal terminal comprises at least one fifth effective level;
in the data refresh phase, the time period of the effective level of the compensation control signal terminal comprises a time period of the at least one fifth effective level, and the time period of the at least one fifth effective level occurs before a time period of at least one first effective level of the first scanning signal terminal;
wherein in the data refresh phase, the time period of the fifth effective level occurs before or after a time period of a fourth effective level of a first reset control signal terminal.

9. (canceled)

10. The pixel circuit of claim 7, wherein the effective level of the second reset control signal terminal comprises at least one sixth effective level;
in the data refresh phase, a time period of the at least one sixth effective level occurs after or before the time period of the effective level of the compensation control signal terminal.

11. The pixel circuit of claim 1, further comprising a third initialization circuit,
wherein the third initialization circuit is coupled with the light-emitting device;
the third initialization circuit is configured to, in response to an effective level of a third reset control signal terminal, provide a signal of the third initialization signal terminal to the light-emitting device;
wherein one of the compensation control signal terminal, the first scanning signal terminal, a first reset control signal terminal and a second reset control signal terminal is a signal terminal same as the third reset control signal terminal.

12. (canceled)

13. The pixel circuit of claim 1, wherein a display frame corresponding to the pixel circuit comprises a refresh sub-frame and a maintaining sub-frame, and an operation of the pixel circuit in the refresh sub-frame is an operation of the pixel circuit in the data refresh phase;
wherein the compensation control signal terminal comprises an invalid level in the maintaining sub-frame;
the light-emitting control signal terminal comprises an invalid level and an effective level in at least one maintaining sub-frame;
the first scanning signal terminal comprises an invalid level and an effective level in at least one maintaining sub-frame.

14. (canceled)

15. The pixel circuit of claim 13, wherein a first reset control signal terminal comprises an invalid level and an effective level in at least one maintaining sub-frame; or
a first reset control signal terminal comprises an invalid level in the maintaining sub-frame.

16. The pixel circuit of claim 13, wherein a second reset control signal terminal comprises an invalid level and an effective level in at least one maintaining sub-frame; or
a second reset control signal terminal comprises an invalid level in the maintaining sub-frame.

17. The pixel circuit of claim 13, wherein a third reset control signal terminal comprises an invalid level and an effective level in at least one maintaining sub-frame; or
a third reset control signal terminal comprises an invalid level in the maintaining sub-frame.

18. The pixel circuit of claim 1, wherein the data-writing circuit comprises a first transistor; a gate of the first transistor is coupled with the first scanning signal terminal, a first electrode of the first transistor is coupled with a data signal terminal, and a second electrode of the first transistor is coupled with the first electrode of the driving transistor;
the threshold compensation circuit comprises a second transistor and a storage capacitor; a gate of the second transistor is coupled with the compensation control signal terminal, a first electrode of the second transistor is coupled with the gate of the driving transistor, a second electrode of the second transistor is coupled with a second electrode of the driving transistor; a first electrode plate of the storage capacitor is coupled with the gate of the driving transistor, and a second electrode plate of the storage capacitor is coupled with a first power supply terminal;
the light-emitting control circuit comprises a third transistor and a fourth transistor; a gate of the third transistor is coupled with the light-emitting control signal terminal, a first electrode of the third transistor is coupled with the first power supply terminal, a second electrode of the third transistor is coupled with the first electrode of the driving transistor, a gate of the fourth transistor is coupled with the light-emitting control signal terminal, a first electrode of the fourth transistor is coupled with the second electrode of the driving transistor, and a second electrode of the fourth transistor is coupled with the light-emitting device;
a first initialization circuit comprises a fifth transistor, a gate of the fifth transistor is coupled with the first reset control signal terminal, a first electrode of the fifth transistor is coupled with the first initialization signal terminal, and a second electrode of the fifth transistor is coupled with the first electrode of the driving transistor;
a second initialization circuit comprises a sixth transistor, a gate of the sixth transistor is coupled with a second reset control signal terminal, a first electrode of the sixth transistor is coupled with a second initialization signal terminal, and a second electrode of the sixth transistor is coupled with the second electrode of the driving transistor;
a third initialization circuit comprises a seventh transistor; a gate of the seventh transistor is coupled with a third reset control signal terminal, a first electrode of the seventh transistor is coupled with a third initialization signal terminal, and a second electrode of the seventh transistor is coupled with the light-emitting device.

19. A pixel circuit, comprising:
a light-emitting device;
a driving transistor configured to generate a driving current that drives the light-emitting device to emit light according to a data voltage;
a light-emitting control circuit coupled with the driving transistor, and configured to, in response to an effective level of a light-emitting control signal terminal, provide the driving current generated by the driving transistor to the light-emitting device, and drive the light-emitting device to emit light;
a functional circuit coupled with the driving transistor, and configured to, in response to a plurality of effective levels that occur at intervals between second scanning signal terminals, operate in a data refresh phase; and
a threshold compensation circuit coupled with the driving transistor, and configured to, in response to an effective level of a compensation control signal terminal, input a threshold voltage of the driving transistor into a gate of the driving transistor;
wherein in the data refresh phase, a time period of an invalid level of the light-emitting control signal terminal comprises a time period of an effective level of the compensation control signal terminal and a time period of an effective level of the second scanning signal terminal, the effective level of the second scanning signal terminal comprises at least one seventh effective level and at least one eighth effective level, and the time period of the effective level of the compensation control signal terminal does not overlap with a time period of the at least one eighth effective level.

20. The pixel circuit of claim 19, wherein the time period of the effective level of the compensation control signal terminal comprises a time period of the seventh effective level; and/or
wherein in the data refresh phase, the time period of the at least one eighth effective level occurs before or after the time period of the effective level of the compensation control signal terminal.

21. (canceled)

22. A display panel comprising a plurality of sub-pixels;
each of the plurality of sub-pixels comprises a pixel circuit, wherein the pixel circuit comprises:
a light-emitting device;
a driving transistor configured to generate a driving current that drives the light-emitting device to emit light according to a data voltage;
a light-emitting control circuit coupled with the driving transistor, and configured to, in response to an effective level of a light-emitting control signal terminal, provide the driving current generated by the driving transistor to the light-emitting device, and drive the light-emitting device to emit light;
a data-writing circuit coupled with a first electrode of the driving transistor, and configured to operate in a data refresh phase in response to a plurality of effective levels that occur at intervals between first scanning signal terminals; and
a threshold compensation circuit coupled with the driving transistor, configured to, in response to an effective level of a compensation control signal terminal, input a threshold voltage of the driving transistor into a gate of the driving transistor;
wherein in the data refresh phase, a time period of an invalid level of the light-emitting control signal terminal comprises a time period of the effective level of the compensation control signal terminal and a time period of an effective level of the first scanning signal terminal, the effective level of the first scanning signal terminal comprises at least one first effective level and at least one second effective level, and the time period of the effective level of the compensation control signal terminal comprises a time period of the first effective level.

23. The display panel of claim 22, wherein in the data refresh phase, a plurality of effective levels of the first scanning signal terminal of the pixel circuit comprise at least one second effective level;
in response to that a time period of at least one second effective level in the at least one second effective level occurs after the time period of the effective level of the compensation control signal terminal, a time period of the second effective level corresponding to a pixel circuit in a n^{th} row of sub-pixels overlaps with a time period of the first effective level corresponding to a pixel circuit in a (n+m)^{th} row of sub-pixels, wherein n is an integer and n>0, and m is an integer and m>0.

24. The display panel of claim 22, wherein in the data refresh phase, a plurality of effective levels of the first scanning signal terminal of the pixel circuit comprise at least one second effective level;
in the data refresh phase, in response to a time period of at least one second effective level in the at least one second effective level occurs before the time period of the effective level of the compensation control signal terminal, a time period of the second effective level corresponding to a pixel circuit in a q^{th} row of sub-pixels overlaps with a time period of the first effective level corresponding to a pixel circuit in a (q−k)^{th} row of sub-pixels, wherein q is an integer and q>0, and k is an integer and k>0;
wherein a time period of the effective level of the compensation control signal terminal of a pixel circuit in a s^{th} row of sub-pixels comprises a time period of the first effective level corresponding to a pixel circuit in the s^{th} to (s−a)^{th} rows of sub-pixels, and a is an integer and a>0;
wherein a time period of the effective level of the compensation control signal terminal of a pixel circuit in a s^{th} row of sub-pixels comprises a time period of the first effective level corresponding to a pixel circuit in the s^{th} to (s+b)^{th} rows of sub-pixels, and b is an integer and b>0.

25-27. (canceled)

28. A driving method for the pixel circuit according to claim 1, comprising: the data refresh phase; wherein the data refresh phase comprises:
in a data threshold compensation phase, operating, by the data-writing circuit, in response to a first effective level of the first scanning signal terminal, and inputting, by the threshold compensation circuit, the threshold voltage of the driving transistor into the gate of the driving transistor in response to the effective level of the compensation control signal terminal;
in a first initialization auxiliary phase, operating, by the data-writing circuit, in response to the second effective level of the first scanning signal terminal;
in a light-emitting stage, providing, by the light-emitting control circuit, the driving current generated by the driving transistor to the light-emitting device to drive the light-emitting device to emit light in response to the effective level of the light-emitting control signal terminal.

29. A driving method for the pixel circuit according to claim 1, comprising:
in a second initialization auxiliary phase, operating, by the data-writing circuit, in response to the second effective level of the first scanning signal terminal;
in a data threshold compensation phase, operating, by the data-writing circuit, in response to the first effective level of the first scanning signal terminal, and inputting, by the threshold compensation circuit, the threshold voltage of the driving transistor into the gate of the driving transistor in response to the effective level of the compensation control signal terminal;
in a light-emitting stage, providing, by the light-emitting control circuit, the driving current generated by the driving transistor to the light-emitting device to drive the light-emitting device to emit light in response to the effective level of the light-emitting control signal terminal.
